(19) United States
(12) Patent Application Publication
(10) Pub. No.: US 2012/0318637 A1
(43) Pub. Date: Dec. 20, 2012

(54) CONVEYANCE SYSTEM, CONVEYANCE DEVICE, ARTICLE, AND INSPECTION SYSTEM

(75) Inventors: Tadanao Ito, Shinagawa-ku (JP); Kenji Fujinuma, Shinagawa-ku (JP); Youichi Kanai, Minato-ku (JP)

(73) Assignees: SHOWA ALUMINUM CAN CORPORATION, Shinagawa-ku, Tokyo (JP); SHOWA DENKO K.K., Minato-ku, Tokyo (JP)

(21) Appl. No.: 13/581,666

(22) PCT Filed: May 10, 2011
(86) PCT No.: PCT/JP2011/060720

§ 371 Date: Aug. 29, 2012

(30) Foreign Application Priority Data
May 14, 2010 (JP) 2010-112160

(51) Int. Cl. B65G 47/244; B32B 3/02

(52) U.S. Cl. 198/339.1; 198/410; 428/192

(57) ABSTRACT

When one side (11b) of the article to be inspected (10) faces the front side of a conveyance device (30) and the first region (R1) of a mounting member (20) is in contact with a first resistance application portion (33A), the sliding between the first region (R1) and the first resistance application portion (33A) is suppressed. Thereby the mounting member (20) moves forward while rotating in the clockwise direction (refer to the reference numeral 5A). Next, when the second region (R2) comes into contact with the first resistance application portion (33A) as indicated by the reference numeral 5B, sliding occurs between the second region (R2) and the first resistance application portion (33A), and the mounting member (20) stops rotating. Then, the mounting member (20) comes into contact with a second resistance application portion (33B), and the mounting member (20) moves forward while rotating in the clockwise direction (refer to the reference numeral 5C). Subsequently, the third region (R3) comes into contact with the second resistance application portion (33B) as indicated by the reference numeral 5D, and the mounting member (20) stops rotating. Thereby, the orientation of an article is changed by a simple configuration.

### TECHNICAL FIELD

The present invention relates to a conveyance system that conveys an article, and the like.

### BACKGROUND ART

An article is usually produced by a conveyor system with a conveyance device such as a belt conveyer. An inspection as to whether a scratch or the like is formed on a surface of the article may be conducted before shipment of the article in some cases. However, if the conveyance of the article is stopped every time the inspection is conducted, decrease in production efficiency is caused. Thus, it is desirable to conduct the inspection while the article is conveyed.

Here, there is suggested a rotation mechanism that gives a bottle rotation due to friction force between the bottle and a conveyer guide provided at both sides in a conveyance direction when the bottle is conveyed by a belt conveyer, to conduct an inspection for scratch on a whole circumference of the bottle (for example, refer to Patent Literature 1).

### CITATION LIST

### Patent Literature

Patent Document 1: Japanese Utility Model (Registration) Application Laid-Open Publication No. Sho 60-88259

### SUMMARY OF INVENTION

### Technical Problem

In the case where plural points of the article are inspected by using a sensor or the like, rotation of the article may be needed in some cases for making each of the plural points face the sensor. In this case, the article can be rotated by using a motor or the like. However, in this case, there is a possibility of increasing the cost or complicating the structure.

### Solution to Problem

A conveyance system to which the present invention is applied includes: an article; and a conveyance device that conveys the article. The conveyance device includes: a conveyance unit that conveys the article along a predetermined conveyance route; a first resistance force application portion that is arranged on a side of the conveyance route, and that comes into contact with an outer circumferential surface of the article to be conveyed in the conveyance route and applies resistance force to the article; and a second resistance force application portion that is arranged on the side of the conveyance route and is arranged on a downstream side of the first resistance force application portion in a conveyance direction of the article and at a position different from the first resistance force application portion in a height direction, and that comes into contact with the outer circumferential surface of the article to be conveyed in the conveyance route and applies resistance force to the article, and the article includes: a main body of the article that has the outer circumferential surface; a first contact region that is provided on the outer circumferential surface of the main body of the article, and that rotates the main body of the article in a circumferential direction by using the resistance force applied by the first resistance force application portion when coming into contact with the first resistance force application portion; a second contact region that is provided on the outer circumferential surface of the main body of the article, and that comes into contact with the first resistance force application portion along with the rotation caused by the contact between the first contact region and the first resistance force application portion and slides the main body of the article with respect to the first resistance force application portion to make sliding movement of the main body of the article; a third contact region that is provided on the outer circumferential surface of the main body of the article, and that comes into contact with the second resistance force application portion along with the sliding movement and rotates the main body of the article in the circumferential direction by using the resistance force applied by the second resistance force application portion; and a fourth contact region that is provided on the outer circumferential surface of the main body of the article, and that comes into contact with the second resistance force application portion along with the rotation caused by the contact between the third contact region and the second resistance force application portion and slides the main body of the article with respect to the second resistance force application portion to make sliding movement of the main body of the article.

Here, the second contact region is provided on one side of the main body of the article, and the fourth contact region is provided on a side opposite to the side where the second contact region is provided. Further, the article is configured with an inspection target object to which a predetermined inspection is conducted and a mounting member mounted on the inspection target object, and the first contact region, the second contact region, the third contact region and the fourth contact region are formed on an outer circumferential surface of the mounting member. Furthermore, the conveyance device further includes: a third resistance force application portion that is arranged on the side of the conveyance route and is arranged on a downstream side of the second resistance force application portion in the conveyance direction of the article and at a position different from the second resistance force application portion in the height direction, and that comes into contact with the outer circumferential surface of the article to be conveyed in the conveyance route and applies resistance force to the article; and a fourth resistance force application portion that is arranged on the side of the conveyance route and is arranged on a downstream side of the third resistance force application portion in the conveyance direction of the article and at a position different from the third resistance force application portion in the height direction, and that comes into contact with the outer circumferential surface of the article to be conveyed in the conveyance route and applies resistance force to the article, and the article further includes: a fifth contact region that is provided on the outer circumferential surface of the main body of the article, and that comes into contact with the third resistance force application portion along with the sliding movement and rotates the main body of the article in the circumferential direction by using the resistance force applied by the third resistance force application portion; a sixth contact region that is provided on the outer circumferential surface of the main body of the article, and that comes into contact with the third resistance force application portion along with the rotation caused by the contact between the fifth contact region and the third resistance force application portion and slides the main body of the article with respect to the third resistance force application portion to make sliding movement of the main body of the article; a seventh contact region that is provided on the outer circumferential surface of the main body of the article, and that comes into contact with the fourth resistance force application portion along with the sliding movement and rotates the main body of the article in the circumferential direction by using the resistance force applied by the fourth resistance force application portion; and an eighth contact region that is provided on the outer circumferential surface of the main body of the article, and that comes into contact with the fourth resistance force application portion along with the rotation caused by the contact between the seventh contact region and the fourth resistance force application portion and slides the main body of the article with respect to the fourth resistance force application portion to make sliding movement of the main body of the article. Still furthermore, the second contact region, the fourth contact region, the sixth contact region and the eighth contact region which slide the main body of the article are arranged to be shifted from each other by about 90 degrees in the circumferential direction of the main body of the article.

If the present invention is considered as a conveyance device, the conveyance device to which the present invention is applied includes: a conveyance unit that conveys, along a predetermined conveyance route, an article having, on an outer circumferential surface, a first surface region and a second surface region which have different surface states and are provided to be adjacent to each other in a circumferential direction and a third surface region and a fourth surface region which have different surface states, which are provided to be adjacent to each other in the circumferential direction, and which are arranged at a position different from that of the first surface region and the second surface region in a height direction; a first rotation and rotation stop unit that has a first contact portion coming into contact with the outer circumferential surface of the article to be conveyed in the conveyance route, that applies resistance force to the first surface region from the first contact portion and rotates the article in the circumferential direction in a case where the first surface region of the article comes into contact with the first contact portion, and that slides the second surface region with respect to the first contact portion and stops the rotation in a case where the second surface region of the article comes into contact with the first contact portion along with the rotation; and a second rotation and rotation stop unit that has a second contact portion arranged on a downstream side of the first contact portion in a conveyance direction of the article, provided at a portion different from the first contact portion in the height direction and coming into contact with the outer circumferential surface of the article having been conveyed, that applies, from the second contact portion, resistance force to the third surface region of the article whose rotation has been stopped by the first rotation and rotation stop unit and rotates the article in the circumferential direction, and that slides the fourth surface region with respect to the second contact portion and stops the rotation in a case where the forth surface region comes into contact with the second contact portion along with the rotation.

Here, the conveyance device further includes: a third rotation and rotation stop unit that has a third contact portion arranged on a downstream side of the second contact portion in the conveyance direction of the article, provided at a portion different from the second contact portion in the height direction and coming into contact with the outer circumferential surface of the article having been conveyed, that applies, from the third contact portion, resistance force to a fifth surface region of the article whose rotation has been stopped by the second rotation and rotation stop unit and rotates the article in the circumferential direction, and that slides, with respect to the third contact portion, a sixth surface region adjacent to the fifth surface region and stops the rotation in a case where the sixth surface region comes into contact with the third contact portion along with the rotation; and a fourth rotation and rotation stop unit that has a fourth contact portion arranged on a downstream side of the third contact portion in the conveyance direction of the article, provided at a portion different from the third contact portion in the height direction and coming into contact with the outer circumferential surface of the article having been conveyed, that applies, from the fourth contact portion, resistance force to a seventh surface region of the article whose rotation has been stopped by the third rotation and rotation stop unit and rotates the article in the circumferential direction, and that slides, with respect to the fourth contact portion, an eighth surface region adjacent to the seventh surface region and stops the rotation in a case where the eighth surface region comes into contact with the fourth contact portion along with the rotation.

If the present invention is considered as an article, the article to which the present invention is applied is capable of being conveyed by a conveyance device having a first contact portion coming into contact with an outer circumferential surface of a conveyed object conveyed in a conveyance route and a second contact portion provided on a downstream side of the first contact portion in a conveyance direction of the conveyed object, provided above or below the first contact portion and coming into contact with the outer circumferential surface of the conveyed object. The article includes: a main body of the article that has an outer circumferential surface; a first contact region that is provided on the outer circumferential surface of the main body of the article, and that comes into contact with the first contact portion along with movement of the main body of the article in the conveyance device and rotates the main body of the article in a circumferential direction by using resistance force applied by the first contact portion; a second contact region that is provided on the outer circumferential surface of the main body of the article, and that comes into contact with the first contact portion along with the rotation caused by the contact between the first contact region and the first contact portion and slides the main body of the article with respect to the first contact portion to make sliding movement of the main body of the article; a third contact region that is provided on the outer circumferential surface of the main body of the article, and that comes into contact with the second contact portion along with the sliding movement and rotates the main body of the article in the circumferential direction by using resistance force applied by the second contact portion; and a fourth contact region that is provided on the outer circumferential surface of the main body of the article, and that comes into contact with the second contact portion along with the rotation caused by the contact between the third contact region and the second contact portion and slides the main body of the article with respect to the second contact portion to make sliding movement of the main body of the article.

Here, the second contact region is provided on one side of the main body of the article, and the fourth contact region is provided on a side opposite to the side where the second contact region is provided.

If the present invention is considered as a conveyance system, the conveyance system to which the present invention is applied includes: an article; and a conveyance device that conveys the article. The conveyance device includes: a conveyance unit that conveys the article along a predetermined conveyance route; a first resistance force application portion that has plural projection portions arranged at plural positions in a conveyance direction of the article and projecting to the conveyance route, and that comes into contact with a side of the article to be conveyed in the conveyance route and applies resistance force to the article; and a second resistance force application portion that has plural projection portions arranged at plural positions in the conveyance direction of the article and projecting to the conveyance route, that is arranged on a downstream side of the first resistance force application portion in the conveyance direction of the article and at a position different from the first resistance force application portion in a height direction, and that comes into contact with the side of the article to be conveyed in the conveyance route and applies resistance force to the article, the article includes: a main body of the article; plural first contact portions that are arranged within a predetermined range in a circumferential direction of the main body of the article and are arranged in the circumferential direction, and that are capable of coming into contact with the plural projection portions provided in the first resistance force application portion; a first region that is located at a portion adjacent to the predetermined range in the circumferential direction, and that does not have the plural first contact portions; and plural second contact portions that are arranged within a predetermined range in the circumferential direction of the main body of the article and are arranged in the circumferential direction, and that are capable of coming into contact with the plural projection portions provided in the second resistance force application portion; and a second region that is located at a portion adjacent to the predetermined range where the plural second contact portions are provided, and that does not have the plural second contact portions. The plural first contact portions of the article moving in the conveyance route sequentially come into contact with the plural projection portions provided in the first resistance force application portion and thereby the article rotates in the circumferential direction, the first region faces a side where the plural projection portions are provided along with the rotation and thereby the rotation of the article stops, the plural second contact portions of the article sequentially come into contact with the plural projection portions provided in the second resistance force application portion and thereby rotation of the article restarts, and the second region faces a side where the plural projection portions are provided along with the rotation and thereby the rotation of the article stops.

Here, the first region is provided on one side of the main body of the article, and the second region is provided on a side opposite to the side where the first region is provided. Further, the article is configured with an inspection target object to which a predetermined inspection is conducted and a mounting member mounted on the inspection target object, and the plural first contact portions, the first region, the plural second contact portions, and the second region are formed in the mounting member. Furthermore, the conveyance device further includes: a third resistance force application portion that has plural projection portions arranged at plural positions in the conveyance direction of the article and projecting to the conveyance route, that is arranged on a downstream side of the second resistance force application portion in the conveyance direction of the article and at a position different from the second resistance force application portion in the height direction, and that comes into contact with the side of the article to be conveyed in the conveyance route and applies resistance force to the article; and a fourth resistance force application portion that has plural projection portions arranged at plural positions in the conveyance direction of the article and projecting to the conveyance route, that is arranged on a downstream side of the third resistance force application portion in the conveyance direction of the article and at a position different from the third resistance force application portion in the height direction, and that comes into contact with the side of the article to be conveyed in the conveyance route and applies resistance force to the article, the article further includes: plural third contact portions that are arranged within a predetermined range in the circumferential direction of the main body of the article and are arranged in the circumferential direction, and that are capable of coming into contact with the plural projection portions provided in the third resistance force application portion; a third region that is located at a portion adjacent to the predetermined range where the plural third contact portions are provided, and that does not have the plural third contact portions; plural fourth contact portions that are arranged within a predetermined range in the circumferential direction of the main body of the article and are arranged in the circumferential direction, and that are capable of coming into contact with the plural projection portions provided in the fourth resistance force application portion; and a fourth region that is located at a portion adjacent to the predetermined range where the plural fourth contact portions are provided, and that does not have the plural fourth contact portions. The plural third contact portions of the article sequentially come into contact with the plural projection portions provided in the third resistance force application portion and thereby rotation of the article restarts, the third region faces a side where the plural projection portions are provided along with the rotation and thereby the rotation of the article stops, the plural fourth contact portions of the article sequentially come into contact with the plural projection portions provided in the fourth resistance force application portion and thereby rotation of the article restarts, and the fourth region faces a side where the plural projection portions are provided along with the rotation and thereby the rotation of the article stops.

If the present invention is considered as a conveyance device, the conveyance device to which the present invention is applied includes: a conveyance unit that conveys an article along a predetermined conveyance route; a first resistance force application portion that has plural projection portions arranged at plural positions in a conveyance direction of the article and projecting to the conveyance route, and that comes into contact with a side of the article to be conveyed in the conveyance route and applies resistance force to the article; and a second resistance force application portion that has plural projection portions arranged at plural positions in the conveyance direction of the article and projecting to the conveyance route, that is arranged on a downstream side of the first resistance force application portion in the conveyance direction of the article and at a position different from the first resistance force application portion in a height direction, and that comes into contact with the side of the article to be conveyed in the conveyance route and applies resistance force to the article.

Here, the conveyance device further includes: a third resistance force application portion that has plural projection portions arranged at plural positions in the conveyance direction of the article and projecting to the conveyance route, that is arranged on a downstream side of the second resistance force application portion in the conveyance direction of the article and at a position different from the second resistance force application portion in the height direction, and that comes into contact with the side of the article to be conveyed in the conveyance route and applies resistance force to the article; and a fourth resistance force application portion that has plural projection portions arranged at plural positions in the conveyance direction of the article and projecting to the conveyance route, that is arranged on a downstream side of the third resistance force application portion in the conveyance direction of the article and at a position different from the third resistance force application portion in the height direction, and that comes into contact with the side of the article to be conveyed in the conveyance route and applies resistance force to the article.

If the present invention is considered as an article, the article to which the present invention is applied is capable of being conveyed by a conveyance device having a first resistance force application portion which has plural projection portions projecting from a side of a conveyance route to the conveyance route, and which comes into contact with a side of a conveyed object to be conveyed in the conveyance route and applies resistance force to the conveyed object, and a second resistance force application portion which is arranged on a downstream side of the first resistance force application portion in a conveyance direction of the conveyed object and is arranged above or below the first resistance force application portion, which has plural projection portions projecting from the side of the conveyance route to the conveyance route, and which comes into contact with the side of the conveyed object to be conveyed in the conveyance route and applies resistance force to the conveyed object. The article includes: a main body of the article; plural first contact portions that are arranged within a predetermined range in a circumferential direction of the main body of the article and are arranged in the circumferential direction, and that sequentially come into contact with the plural projection portions provided in the first resistance force application portion and rotate the main body of the article in the circumferential direction; a first section that is located at a section adjacent to the predetermined range, that does not have the plural first contact portions, and that faces a side where the first resistance force application portion is provided along with the rotation and stops the rotation; plural second contact portions that are arranged within a predetermined range in the circumferential direction of the main body of the article and are arranged in the circumferential direction, and that sequentially come into contact with the plural projection portions provided in the second resistance force application portion along with movement of the main body of the article and rotate the main body of the article in the circumferential direction; and a second section that is located at a section adjacent to the predetermined range where the plural second contact portions are provided, that does not have the plural second contact portions, and that faces a side where the second resistance force application portion is provided along with the rotation and stops the rotation.

Here, the article further includes: plural third contact portions that are arranged within a predetermined range in the circumferential direction of the main body of the article and are arranged in the circumferential direction, and that sequentially come into contact with the plural projection portions provided in a third resistance force application portion arranged on a downstream side of the second resistance force application portion in the conveyance direction of the article and at a position different from the second resistance force application portion in a height direction and rotate the main body of the article in the circumferential direction; a third section that is located at a section adjacent to the predetermined range where the plural third contact portions are provided, that does not have the plural third contact portions, and that faces a side where the third resistance force application portion is provided along with the rotation and stops the rotation; plural fourth contact portions that are arranged within a predetermined range in the circumferential direction of the main body of the article and are arranged in the circumferential direction, and that sequentially come into contact with the plural projection portions provided in a fourth resistance force application portion arranged on a downstream side of the third resistance force application portion in the conveyance direction of the article and at a position different from the third resistance force application portion in the height direction and rotate the main body of the article in the circumferential direction; and a fourth section that is located at a section adjacent to the predetermined range where the plural fourth contact portions are provided, that does not have the plural fourth contact portions, and faces a side where the fourth resistance force application portion is provided along with the rotation and stops the rotation.

If the present invention is considered as an inspection system, the inspection system to which the present invention is applied includes: an article; a conveyance device that conveys the article; and an inspection unit that inspects the article to be conveyed by the conveyance device. The conveyance device includes: a conveyance unit that conveys the article along a predetermined conveyance route; a first resistance force application portion that is arranged on a side of the conveyance route, and that comes into contact with an outer circumferential surface of the article to be conveyed in the conveyance route and applies resistance force to the article; and a second resistance force application portion that is arranged on the side of the conveyance route and is arranged on a downstream side of the first resistance force application portion in a conveyance direction of the article and at a position different from the first resistance force application portion in a height direction, and that comes into contact with the outer circumferential surface of the article to be conveyed in the conveyance route and applies resistance force to the article, and the article includes: a main body of the article that has the outer circumferential surface: a first contact region that is provided on the outer circumferential surface of the main body of the article, and that rotates the main body of the article in a circumferential direction by using the resistance force applied by the first resistance force application portion when coming into contact with the first resistance force application portion; a second contact region that is provided on the outer circumferential surface of the main body of the article, and that comes into contact with the first resistance force application portion along with the rotation caused by the contact between the first contact region and the first resistance force application portion and slides the main body of the article with respect to the first resistance force application portion to make sliding movement of the main body of the article; a third contact region that is provided on the outer circumferential surface of the main body of the article, and that comes into contact with the second resistance force application portion along with the sliding movement and rotates the main body of the article in the circumferential direction by using the resistance force applied by the second resistance force application portion; and a fourth contact region that is provided on the outer circumferential surface of the main body of the article, and that comes into contact with the second resistance force application portion along with the rotation caused by the contact between the third contact region and the second resistance force application portion and slides the main body of the article with respect to the second resistance force application portion to make sliding movement of the main body of the article.

From another viewpoint, the inspection system to which the present invention is applied includes: an article; a conveyance device that conveys the article; and an inspection unit that inspects the article to be conveyed by the conveyance device. The conveyance device includes: a conveyance unit that conveys the article along a predetermined conveyance route; a first resistance force application portion that has a plurality of projection portions arranged at plural positions in a conveyance direction of the article and projecting to the conveyance route, and that comes into contact with a side of the article to be conveyed in the conveyance route and applies resistance force to the article; and a second resistance force application portion that has plural projection portions arranged at plural positions in the conveyance direction of the article and projecting to the conveyance route, that is arranged on a downstream side of the first resistance force application portion in the conveyance direction of the article and at a position different from the first resistance force application portion in a height direction, and that comes into contact with the side of the article to be conveyed in the conveyance route and applies resistance force to the article, the article includes: a main body of the article; plural first contact portions that are arranged within a predetermined range in a circumferential direction of the main body of the article and are arranged in the circumferential direction, and that are capable of coming into contact with the plural projection portions provided in the first resistance force application portion; a first region that is located at a portion adjacent to the predetermined range in the circumferential direction, and that does not have the plural first contact portions; plural second contact portions that are arranged within a predetermined range in the circumferential direction of the main body of the article and are arranged in the circumferential direction, and that are capable of coming into contact with the plural projection portions provided in the second resistance force application portion; and a second region that is located at a portion adjacent to the predetermined range where the plural second contact portions are provided, and that does not have the plural second contact portions. The plural first contact portions of the article moving in the conveyance route sequentially come into contact with the plural projection portions provided in the first resistance force application portion and thereby the article rotates in the circumferential direction, the first region faces a side where the plural projection portions are provided along with the rotation and thereby the rotation of the article stops, the plural second contact portions of the article sequentially come into contact with the plural projection portions provided in the second resistance force application portion and thereby rotation of the article restarts, and the second region faces a side where the plural projection portions are provided along with the rotation and thereby the rotation of the article stops.

### Advantageous Effects of Invention

According to the present invention, it is possible to change an orientation of an article by a simple configuration.

### BRIEF DESCRIPTION OF DRAWINGS

FIG. 1 is a view for showing a schematic configuration of an inspection system according to the exemplary embodiment of the present invention;

FIGS. 2A to 2C are views for illustrating the conveyance device;

FIGS. 3A to 3D are views for illustrating the mounting member;

FIG. 4 is a view for illustrating the behavior of the article to be inspected and the mounting member in the conveyance device;

FIG. 5 is a view for illustrating the behavior of the article to be inspected and the mounting member in the conveyance device;

FIG. 6 is a view for showing another configuration of the conveyance device;

FIGS. 7A and 7B are views for illustrating another configuration of the mounting member;

FIGS. 8A and 8B are views for illustrating further configuration of the mounting member;

FIGS. 9A to 9D are views for showing furthermore configuration of the mounting member;

FIG. 10 is a view for illustrating the conveyance device in the exemplary embodiment, and is a top view of the conveyance device;

FIG. 11 is a view for illustrating the behavior of the mounting member in the conveyance device;

FIG. 12 is a view for illustrating the behavior of the mounting member in the conveyance device;

FIG. 13 is a top view of the conveyance device in the second exemplary embodiment;

FIG. 14 is a right side view of the conveyance device;

FIGS. 15A and 15B are perspective views of the mounting member;

FIGS. 16A and 16B are cross-sectional views of the mounting member;

FIG. 17 is a view for showing the behavior of the article to be inspected (mounting member) in the conveyance device;

FIG. 18 is a view for showing the behavior of the article to be inspected (mounting member) in the conveyance device;

FIG. 19 is a view for illustrating another configuration of the mounting member;

FIGS. 20A and 20B are views for illustrating another configuration of the mounting member;

FIG. 21 is a view for showing another configuration of the conveyance device;

FIG. 22 is a view for showing the behavior of the mounting member (article to be inspected) in the conveyance device;

FIG. 23 is a view for showing the behavior of the mounting member (article to be inspected) in the conveyance device;

FIGS. 24A and 24B are views for illustrating furthermore configuration of the mounting member;

FIG. 25 is a view for showing the behavior of the mounting member (article to be inspected) in the conveyance device;

FIG. 26 is a view for showing the behavior of the mounting member (article to be inspected) in the conveyance device; and

FIG. 27 is a view for showing another configuration example of the conveyance device and the mounting member.

### DESCRIPTION OF EMBODIMENTS

Hereinafter, exemplary embodiments of the present invention will be described in detail with reference to the accompanying drawings.

### First Exemplary Embodiment

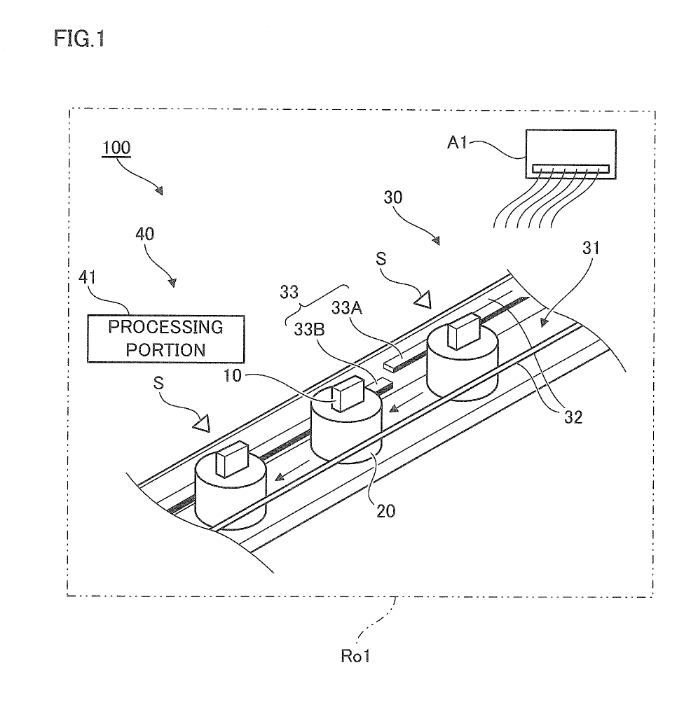

FIG. 1 is a view for showing a schematic configuration of an inspection system 100 according to the exemplary embodiment of the present invention.

The inspection system 100 has an article to be inspected 10 such as an electronic component, a mounting member 20 that is mounted on the article to be inspected 10, a conveyance device 30 that conveys the article to be inspected 10 on which the mounting member 20 has been mounted, and an inspection unit 40 that inspects the article to be inspected 10.

The conveyance device 30 is provided with: a placement unit 31 (an example of a conveyance unit) where the article to be inspected 10 (an example of an article) on which the mounting member 20 has been mounted is placed, and which conveys the article to be inspected 10; a guide 32 that guides the article to be inspected 10 which is to be conveyed; and a resistance application portion 33 that is provided to the guide 32, and comes into contact with an outer circumferential surface of the mounting member 20 to apply sliding resistance (friction resistance) onto the outer circumferential surface. Here, the resistance application portion 33 is configured with a first resistance application portion 33A (an example of a first resistance force application portion and a first contact portion) that is arranged on an upstream side in the conveyance direction of the article to be inspected 10, and a second resistance application portion 33B (an example of a second resistance force application portion and a second contact portion) that is arranged on a downstream side in the conveyance direction of the article to be inspected 10. Here, in the exemplary embodiment, the first resistance application portion 33A is arranged above the second resistance application portion 33B in the height direction of the conveyance device 30.

Meanwhile, the inspection unit 40 is provided with a charge-coupled device (CCD) camera S that outputs the surface state of the article to be inspected 10 as image data. Further, the inspection unit 40 is provided with a processing portion 41. The processing portion 41 determines presence or absence of a scratch on the article to be inspected 10 on the basis of the image data outputted from the CCD camera S, and drives a conveyance route switching member (not shown) provided on the moving route of the article to be inspected 10 in the case of the presence of the scratch. Thereby, the article to be inspected 10 having a scratch leaves the main conveyance route, and is collected in a predetermined collecting site (not shown). In the exemplary embodiment, presence or absence of a scratch on the article to be inspected 10 is determined. However, it is only an example, and determination whether a print position of words, illustration or the like is appropriate or not can be made. Note that, the processing portion 41 is configured with a central processing unit (CPU) that executes an arithmetic processing, a non-volatile read only memory (ROM) and a hard disk drive (HDD) in which a control program has been memorized, a random access memory (RAM) that temporarily memorizes data, a peripheral devices thereof, and the like.

As shown in FIG. 1, the inspection system 100 is installed in an inspection room Ro1 where temperature is controlled by a temperature regulating device A1 so that the room is kept at constant temperature. On the upstream side in the conveyance direction of the article to be inspected 10, a supplying portion (not shown) where the article to be inspected 10 is supplied to the placement unit 31 of the conveyance device 30 is provided. The article to be inspected 10 which has been supplied from the supplying portion moves on the placement unit 31 from the upstream side to the downstream side. As mentioned above, in the exemplary embodiment, the CCD camera S is provided. As an additional note, in the exemplary embodiment, plural CCD cameras S are provided at different positions in the conveyance direction of the article to be inspected 10.

Here, the surface state of the article to be inspected 10 is outputted as image data from the CCD camera S to the processing portion 41, and presence or absence of a scratch on the article to be inspected 10 is determined in the processing portion 41, as mentioned above. Note that, in the description, the upstream side in the conveyance direction of the mounting member 20 may be referred to as a back side (rear side), and the downstream side may be referred to as a near side (front side), in some cases. In addition, a direction orthogonal to the conveyance direction (moving direction of the article to be inspected 10) may be referred to as a horizontal direction or a width direction in some cases.

Further detailed description will be given for the conveyance device 30.

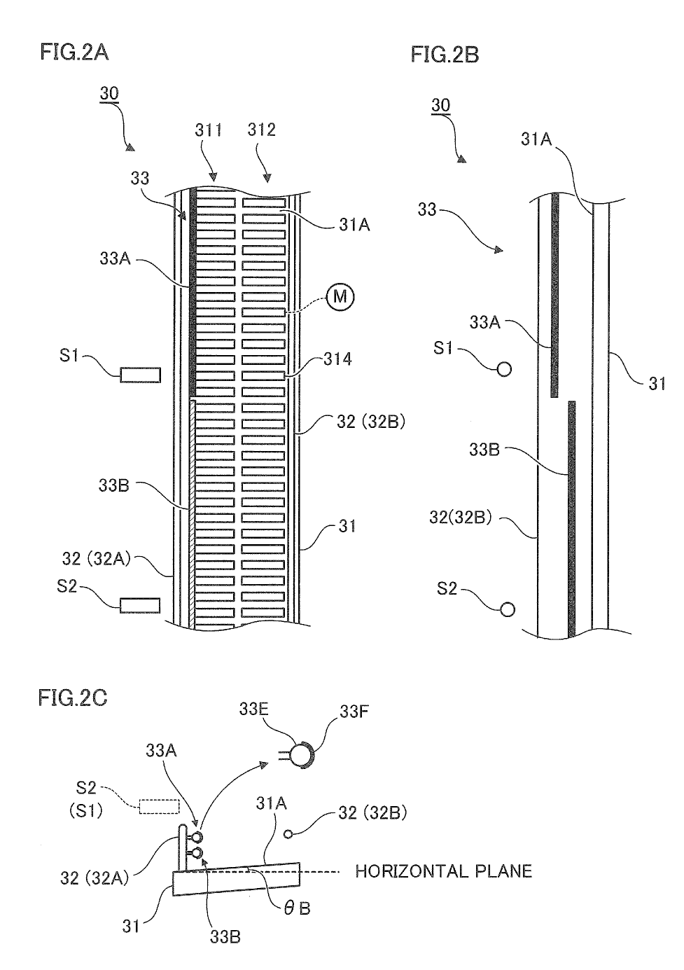

FIGS. 2A to 2C are views for illustrating the conveyance device 30. Note that, FIG. 2A is a top view of the conveyance device 30. FIG. 2B is a right side view of the conveyance device 30. FIG. 2C is a front view of the conveyance device 30.

The guide 32 is provided along the both sides of the conveyance route of the article to be inspected 10. This guide 32 has a left guide 32A on one side (left side in FIG. 2A) of the conveyance route of the article to be inspected 10, and a right guide 32B on the other side (right side in FIG. 2A) of the conveyance route of the article to be inspected 10. Here, the guide 32 is composed of a metallic material such as aluminum, or a resin material. In the exemplary embodiment, the resistance application portion 33 is provided to the left guide 32A. Note that, in the exemplary embodiment, two guides 32 which are the left guide 32A and the right guide 32B are provided. However, the right guide 32B can be omitted.

The placement unit 31 is arranged to be inclined in the horizontal direction (width direction) of the conveyance device 30. Specifically, the placement unit 31 is arranged to be inclined so that the left guide 32A side is located below the right guide 32B side. More specifically, the placement unit 31 is arranged to be inclined so that the placement unit 31 (a placement surface 31A) and the horizontal plane in the horizontal direction form an angle OB with each other and the left guide 32A side is located below the right guide 32B side.

The placement unit 31 has, on the placement surface 31A as a surface where the mounting member 20 is to be placed, a first roller array 311 and a second roller array 312 which are arranged in parallel in the width direction of the conveyance device 30. Here, the first roller array 311 is provided on the left guide 32A side, and the second roller array 312 is provided on the right guide 32B side. Note that, each roller array has plural roll-shaped members 314 arrayed from the supplying portion of the article to be inspected 10 to the front side. Here, the roll-shaped members 314 contained in the first roller array 311 and the second roller array 312 are rotated by a motor M, and smoothly move the article to be inspected 10 and the mounting member 20.

Next, description will be given for the resistance application portion 33. As mentioned above, in the exemplary embodiment, at the left guide 32A, the resistance application portion 33 that applies sliding resistance (frictional resistance, resistance force) onto the outer circumferential surface of the contacting mounting member 20 is provided. The resistance application portion 33 is configured with the first resistance application portion 33A arranged on the upstream side in the conveyance direction of the article to be inspected 10, and the second resistance application portion 33B arranged on the downstream side in the conveyance direction of the article to be inspected 10, as mentioned above. Here, each of the first resistance application portion 33A and the second resistance application portion 33B is provided along the conveyance route of the article to be inspected 10.

Further, as shown in FIG. 2C, each of the first resistance application portion 33A and the second resistance application portion 33B is configured with a cylindrical base 33E that is provided along the conveyance route of the article to be inspected 10 and is fixed to the left guide 32A, and an attached member 33F that has been attached onto the outer surface of the base 33E. Note that, the cross-section of the base 33E is desirably a circular shape. As an additional note, a section (facing side) of the resistance application portion 33, which comes into contact with the mounting member 20, is desirably formed to have a curvature and to expand toward the side where the conveyance route is provided. This is because the contact area between the resistance application portion 33 and the mounting member 20 tends to be constant even if the mounting member 20 moves in the up-and-down direction or the horizontal direction when the mounting member 20 moves on the conveyance route.

Note that, the base 33E in the exemplary embodiment is composed of aluminum. As the attached member 33F in the exemplary embodiment, a commercially available plastic tape (specifically, a tape composed of vinyl chloride) whose surface is more smoothly formed than the surface of the base 33E is used. Note that, another plastic tape composed of a material other than vinyl chloride, or a rubber member such as EPDM can be attached.

As mentioned above, in the exemplary embodiment, the CCD cameras S which output the surface state of the article to be inspected 10 as image data are provided (refer to FIG. 1). More specifically, in the exemplary embodiment, as shown in FIG. 2A, two cameras which are a first CCD camera S1 and a second CCD camera S2 are provided as the CCD cameras S.

Next, description will be given for the mounting member 20.

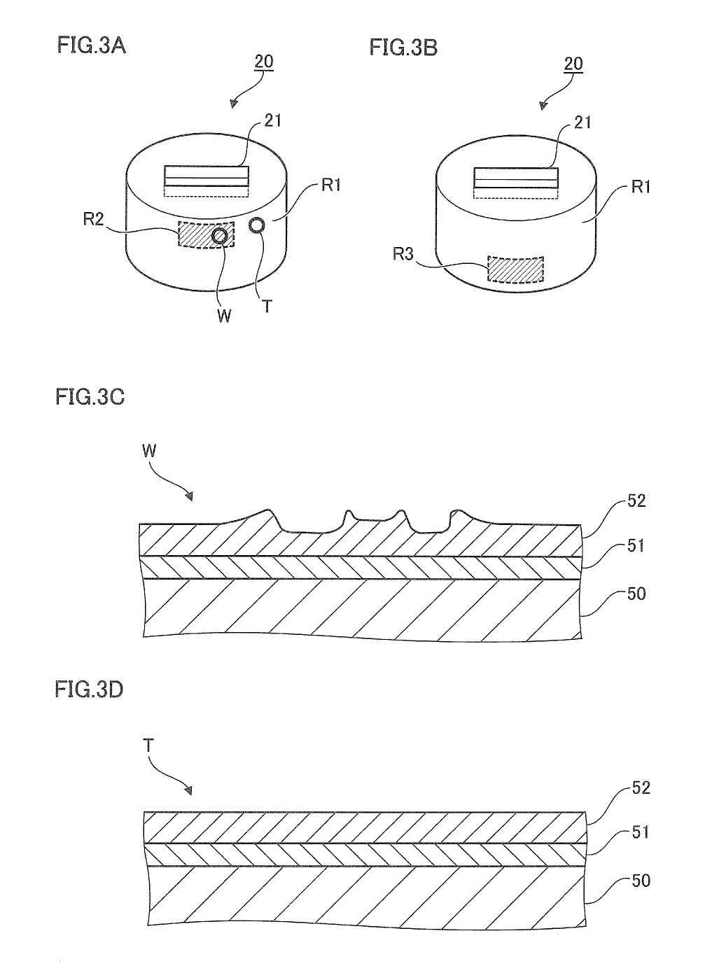

FIGS. 3A to 3D are views for illustrating the mounting member 20. Note that, FIG. 3A is an illustration of the mounting member 20 from one side, and FIG. 3B is an illustration of the mounting member 20 from the other side. Further, FIG. 3C shows a cross-section of a W part in FIG. 3A, and FIG. 3D shows a cross-section of a T part in FIG. 3A. As an additional note, FIG. 3C shows a cross-section of a second region R2 to be described later, and FIG. 3D shows a cross-section of a first region R1 to be described later.

The mounting member 20 is configured by a cylindrical member, and a mounting portion 21 that is mounted on the article to be inspected 10 is provided at the top surface thereof. Here, the mounting portion 21 is formed to be a rectangle, and has a dent toward the inside direction of the mounting member 20. Further, as shown in FIGS. 3A and 3B, the mounting member 20 in the exemplary embodiment has the first region R1 (an example of first and third contact regions, or first and third surface regions), the second region R2 (an example of a second contact region or a second surface region) and a third region R3 (an example of a fourth contact region or a fourth surface region) on the outer circumferential surface. Here, the second region R2 and the third region R3 are arranged to be shifted by 180 degrees in the circumferential direction of the mounting member 20. As an additional note, the second region R2 is provided on one side of the mounting member 20, and the third region R3 is provided on a side opposite to the one side. Further, the second region R2 and the third region R3 are arranged so as not to be aligned in the height direction of the mounting member 20. In the exemplary embodiment, a region of the outer circumferential surface of the mounting member 20 other than the second region R2 and the third region R3 is the first region R1.

Note that, the surface states of the second region R2 and the third region R2 are formed in the same manner. Thus, in the following description, the first region R1 and the second region R2 will be mainly described. Further, in the exemplary embodiment, a frictional coefficient at the surface is such that the first region R1>the second region R2 (third region R3) is satisfied. The mounting portion 21 has a shape according to the cross-sectional shape of the article to be inspected (inspection target object) 10, and the shape seen from the above is approximately a rectangle. Note that, in the exemplary embodiment, the second region R2 is formed on one region side having a boundary as the mounting portion 21, and the third region R3 is formed on the other region side.

Here, detailed description will be given for the surface state of the second region R2 (third region R3) with reference to FIG. 3C. As shown in FIG. 3C, in the second region R2, an ink layer 51 is provided on the surface of a main body 50 of the mounting member (an example of a main body of an article). Also, a topcoat layer (an outermost layer) 52 having concavities and convexities in crater form is provided on the surface of the ink layer 51.

Here, the ink layer 51 contains a pigment as a color material. As the pigment, various kinds of organic pigments or inorganic pigments can be used. Also, a vehicle of the ink contains a resin such as a thermosetting resin or an ultraviolet-curing resin, as a main ingredient. Here, an alkyd type or polyester type resin or the like is used as the thermosetting resin. Also, an ultraviolet radical polymerization type or ultraviolet cationic polymerization type resin or the like is used as the ultraviolet-curing resin. Further, the ink may contain an additive. A matting agent, wax (natural wax, petroleum wax, or synthetic wax), a desiccant, a dispersant, a wetting agent, a crosslinking agent, a gelling agent, a puffing agent, an anti-skinning agent, a stabilizer, an anti-foaming agent, a photopolymerization initiator, or the like is used as the additive.

Also, the ink layer 51 is made of what is called repellent ink. Specifically, the ink layer 51 is made of ink that repels a coating material when the coating material to form the topcoat layer 52 is applied to the surface of the ink layer 51. Here, the coating material to form the topcoat layer 52 is repelled by the ink layer 51 thereby to form the above-mentioned concavities and convexities of the topcoat layer 52. Note that, although the second region R2 is colored with a color material in the exemplary embodiment, the second region R2 can be colorless without a color material as a matter of course.

In order that the coating material to form the topcoat layer 52 is repelled by the ink layer 51 (in order that the above-mentioned concavities and convexities are formed), it is desirable that surface tension of the ink used to form the ink layer 51 be set lower than surface tension of the coating material used to form the topcoat layer 52, by 5 mN/m or more. In other words, it is desirable that the surface tension of the ink be lower than the surface tension of the coating material and difference in surface tension between the ink and the coating material be 5 mN/m or more. Here, a reduction in the surface tension of the ink may be accomplished for example by adding silicone to typical ink.

Meanwhile, the coating material for use in the topcoat layer 52 contains a resin such as a thermosetting resin or an ultraviolet-curing resin, as a main ingredient, and contains a wax component as needed. A phenol-formaldehyde resin, a furan-formaldehyde resin, a xylene-formaldehyde resin, a ketone-formaldehyde resin, an amino resin, a urea formaldehyde resin, a melamine-formaldehyde resin, an alkyd resin, an unsaturated polyester resin, an epoxy resin (e.g., a novolak type epoxy resin or a bisphenol type epoxy resin), a bismaleimide resin, a triallyl cyanurate resin, a thermosetting acrylic resin, a silicone resin, an oil-based resin, or the like is used as the thermosetting resin.

Further, a compound of a thermosetting resin and a thermoplastic resin may be used. In this case, a vinyl chloride-maleic acid-vinyl acetate copolymer, an acrylic polymer, a saturated polyester resin, or the like is used as the thermoplastic resin. These resins may be used singly, or two or more resins may be used in combination. Also, these resin compounds may have a known acid catalyst, such as toluenesulfonic acid or benzenesulfonic acid, added thereto as needed. When the acid catalyst is used, it is desirable that the acid catalyst which is 0.5 to 1 wt % of the resin be added thereto. Also, of these resins, it is desirable that a compound of a melamine-formaldehyde resin and a saturated polyester resin or a compound of a thermosetting acrylic resin and a melamine-formaldehyde resin, in particular, be used in terms of coating film performance.

Meanwhile, a cation cure resin, a radical cure resin, or the like, for example, is used as the ultraviolet-curing resin. A compound of an ultraviolet-curing epoxy resin and a photo-cationic polymerization catalyst, or the like is used as the cation cure resin.

Also, the coating material for use in the topcoat layer 52 may contain a crosslinking agent or a sensitizing agent added to the above-mentioned resin as needed. Various polyols (e.g., ε-caprolactone triol) or the like is used as the crosslinking agent. A thioxanthone derivative or the like is used as the sensitizing agent. Further, natural, petroleum and synthetic waxing compounds may be added as a wax component singly or in combination to the coating material for use in the topcoat layer 52, in order to assist in sliding. Furthermore, various silicone oils may be added as a leveling agent for the surface of the topcoat layer 52, and/or for the purpose of improving stability in a coated state or imparting initial sliding properties to the topcoat layer 52.

Note that a specific example of composition and the like of the ink layer 51 and the topcoat layer 52 is listed as follows.

<Topcoat layer 52>

Resin component: polyester 30%, acrylic 13%, amino 55%, epoxy 2%

Wax: petroleum 0.3%, natural 1%, synthetic 0.2% (with respect to resin component)

Silicone oil (mixed): 0.15% (with respect to resin component)

Surface tension: 33 mN/m

Thickness: 5 μm

<Ink layer 51>(repellent ink)

Main resin: alkyd resin

Pigment: TiO₂

Surface tension: 28 mN/m

Thickness: 2 μm

Note that the above is description of a specific example of a method for forming the second region R2, and a technique disclosed in Japanese Patent Application Laid Open Publication No. 2002-361172, for example, may be used to form the second region R2. That is, concavities and convexities may be formed by aggregating the coating material to form the topcoat layer 52 on the surface of the ink layer 51 in the form of spots, thereby to form the second region R2. Further, the concavities and convexities in crater form in the second region R2 can be formed by forming the ink layer 51 with a so-called foam ink which contains a foaming agent.

Next, description will be given for the surface state of the first region R1 with reference to FIG. 3D.

As shown in FIG. 3D, in the first region R1, the ink layer 51 is provided on the surface of the main body 50 of the mounting member, as in the case of the above. Also, the topcoat layer (outermost layer) 52 whose surface is formed more smoothly than that of the topcoat layer 52 in the above-mentioned second region R2 is provided on the surface of the ink layer 51.

Here, the ink layer 51 in the first region R1 is formed by using ink (typical ink) that does not repel the coating material to form the topcoat layer 52. As an additional note, ink whose surface tension is equal to or higher than the surface tension of the coating material to form the topcoat layer 52 is used as the ink to form the ink layer 51. Thus, in the first region R1, the coating material to form the topcoat layer 52 is not repelled, and the surface of the topcoat layer 52 is smooth as compared to the topcoat layer 52 in the second region R2. A basic composition and the like of the ink to form the ink layer 51 are the same as described above. A basic composition and the like of the coating material to form the topcoat layer 52 are the same as described above.

Next, description will be given for behavior of the article to be inspected 10 and the mounting member 20 in the conveyance device 30.

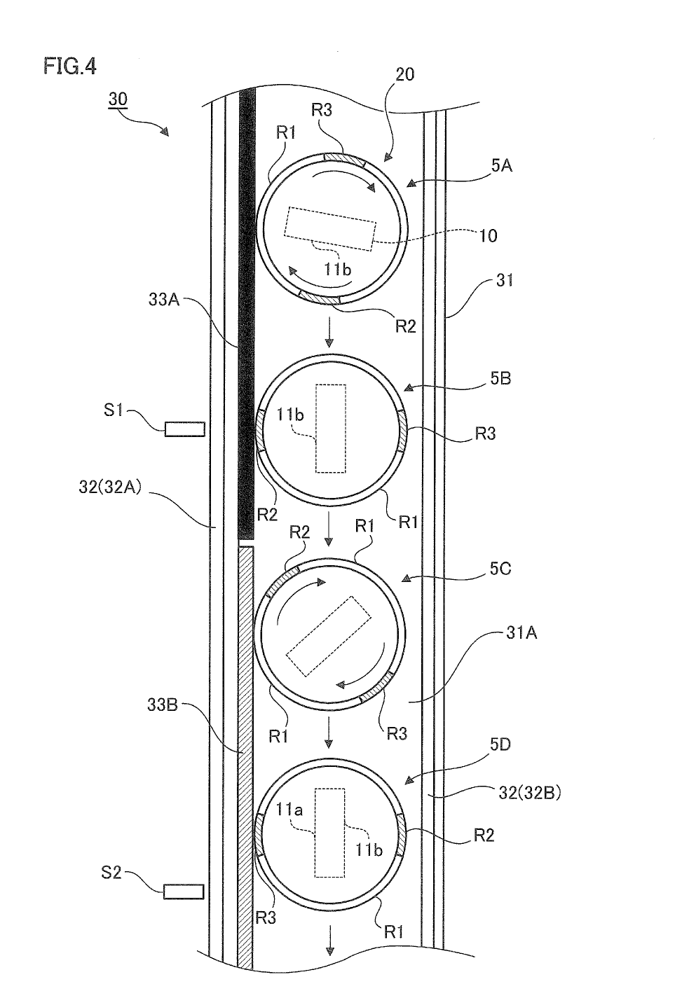

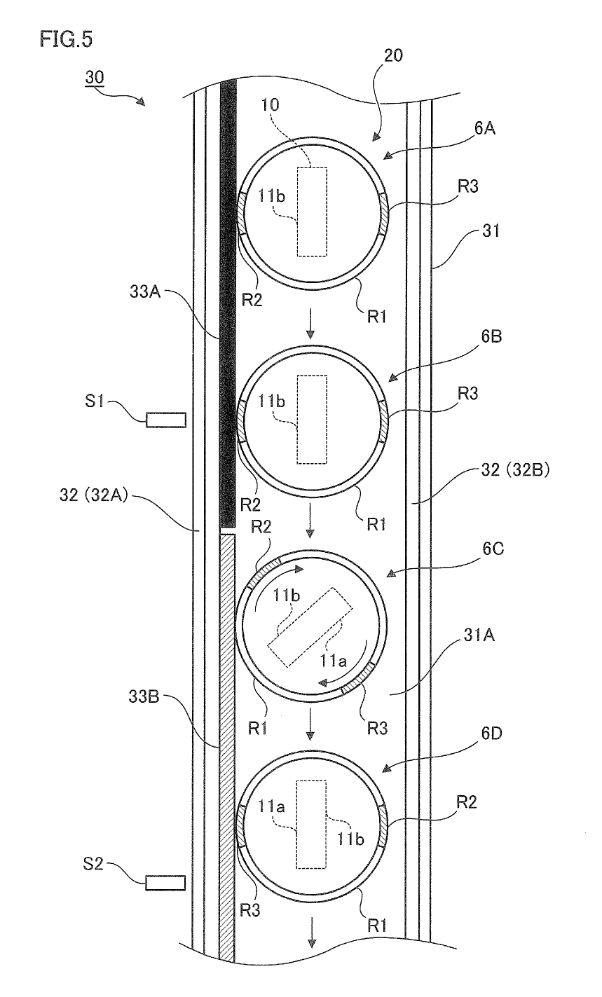

FIG. 4 and FIG. 5 are views for illustrating the behavior of the article to be inspected 10 and the mounting member 20 in the conveyance device 30. Note that, in FIG. 4 and FIG. 5, illustrations of the first roller array 311 and the second roller array 312 (refer to FIG. 2A) are omitted. Also, the second resistance application portion 33B is illustrated with hatching in order that the drawing may be readily seen.

As the article to be inspected 10 on which the mounting member 20 has been mounted is supplied to the conveyance device 30, it is guided by the placement surface 31A, and the mounting member 20 moves toward the left guide 32A side and the font side. Thereby, the mounting member 20 comes into contact with the first resistance application portion 33A. Then, the mounting member 20 moves frontward while being guided by the first resistance application portion 33A (refer to a reference numeral 5A). At this time, sliding between the first region R1 and the first resistance application portion 33A is suppressed (resistance force is applied to the first region R1) if one side 11b of the article to be inspected 10 faces a front side of the conveyance device 30 and the first region R1 of the mounting member 20 is in contact with the first resistance application portion 33A. Thereby, the mounting member 20 moves frontward while rotating in the clockwise direction (refer to the reference numeral 5A).

Then, as indicated by a reference numeral 5B, when the second region R2 comes into contact with the first resistance application portion 33A, sliding occurs between the second region R2 and the first resistance application portion 33A, and the mounting member 20 thus stops rotating. Thereby, the one side 11b of the article to be inspected 10 faces the left guide 32A side. Note that, in the case where the second region R2 comes into contact with the first resistance application portion 33A, the second region R2 and the first resistance application portion 33A are nearly in point contact with each other. As an additional note, the second region R2 and the first resistance application portion 33A are in a state where a contact area therebetween decreases. It is conceivable that the above-mentioned sliding thus occurs between the second region R2 and the first resistance application portion 33A. Thereafter, the mounting member 20 moves (slides) toward the front side while being guided by the first resistance application portion 33A. When the mounting member 20 reaches the vicinity of the end of the first resistance application portion 33A on the downstream side, the one side 11B of the article to be inspected 10 is captured by the first CCD camera S1.

After that, in the exemplary embodiment, the article to be inspected 10 and the mounting member 20 further move frontward, and the mounting member 20 comes into contact with the second resistance application portion 33B. Specifically, the first region R1 provided to the mounting member 20 comes into contact with the second resistance application portion 33B. More specifically, a region (an example of a third contact region or a third surface region) of the first region R1, which is located below the second region R2 (refer to FIG. 3A), comes into contact with the second resistance application portion 33B. In this case, sliding between the region located therebelow and the second resistance application portion 33B is suppressed, and the mounting member 20 moves frontward while rotating in the clockwise direction (refer to a reference numeral 5C in FIG. 4).

Then, as indicated by a reference numeral 5D, the third region R3 comes into contact with the second resistance application portion 33B, sliding occurs between the third region R3 and the second resistance application portion 33B similarly to the above, and the mounting member 20 stops rotating. Thereby, the other side 11a of the article to be inspected 10 faces the left guide 32A side. Thereafter, the mounting member 20 moves (slides) toward the front side while being guided by the second resistance application portion 33B. When the mounting member 20 reaches the vicinity of the end of the second resistance application portion 33B on the downstream side, the other side 11a of the article to be inspected 10 is captured by the second CCD camera S2. After that, the article to be inspected 10 and the mounting member 20 further move frontward, and they are conveyed for the next inspection process (not shown).

Note that, in the above description, the behavior in the case where the article to be inspected 10 is supplied in the state where the one side 11b faces the front side of the conveyance device 30 (refer to the reference numeral 5A in FIG. 4) has been explained. However, as indicated by a reference numeral 6A in FIG. 5 (view for showing another example of the behavior of the mounting member 20 in the conveyance device 30), the article to be inspected 10 and the mounting member 20 may be supplied in the state where the one side 11b faces the left guide 32A side. In this case, since the second region R2 of the mounting member 20 and the first resistance application portion 33A comes into contact with each other, the mounting member 20 moves without rotation (refer to a reference numeral 6B). Then, similarly to the above, the one side 11b is captured by the first CCD camera S1. Incidentally, after that, the behavior similar to that in the above description will be done. That is, the rotation of the mounting member 20 is firstly conducted (refer to a reference numeral 6C), and then the rotation of the mounting member 20 is stopped (refer to a reference numeral 6D). Further, the other side 11a is captured by the second CCD camera S2.

Here, in the conveyance device 30 in the exemplary embodiment, the first resistance application portion 33A and the second resistance application portion 33B are arranged so as not to be aligned in the height direction of the conveyance device 30. However, the first resistance application portion 33A and the second resistance application portion 33B can be arranged so as to be aligned in the height direction. As an additional note, the second resistance application portion 33B can be provided on an extended line of the first resistance application portion 33A. However, if such an arrangement is simply adopted, the rotation of the mounting member 20 in the circumferential direction is not conducted when the mounting member 20 reaches the facing position of the second resistance application portion 33B. Specifically, with reference to FIG. 4, the second region R2 comes into contact with the second resistance application portion 33B in the state indicated by the reference numeral 5C for example, sliding occurs between the second region R2 and the second resistance application portion 33B, and thus the rotation of the mounting member 20 in the circumferential direction is not conducted.

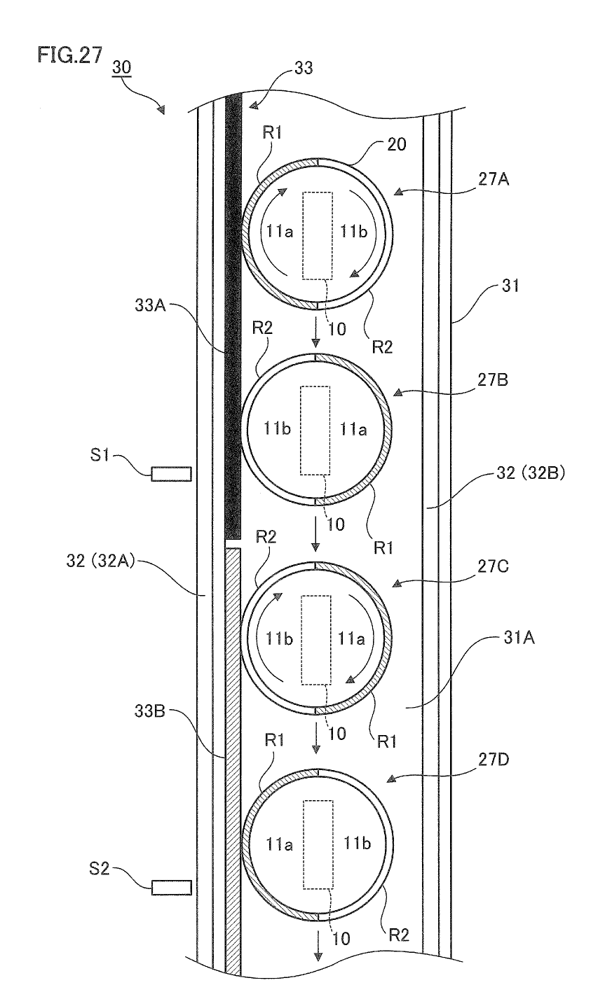

Accordingly, in the case where the second resistance application portion 33B is provided on the extended line of the first resistance application portion 33A, the material of the second resistance application portion 33B is made different from the material of the first resistance application portion 33A, and it is necessary that the sliding between the second resistance application portion 33B and the mounting member 20 does not occur. Specifically, by adopting a configuration shown in FIG. 27 (view for showing another configuration example of the conveyance device 30 and the mounting member 20), the mounting member 20 can be appropriately rotated and stop rotating even in the case where the second resistance application portion 33B is provided on the extended line of the first resistance application portion 33A.

Here, in the conveyance device 30 in FIG. 27, the first region R1 and the second region R2 are provided on the outer circumferential surface of the mounting member 20 similarly to the above. Here, in the configuration in FIG. 27, the material of the second resistance application portion 33B is different from the material of the first resistance application portion 33A. In this configuration, sliding between the first region R1 of the mounting member 20 and the first resistance application portion 33A is to be suppressed, and sliding between the first region R1 and the second resistance application portion 33B is to occur. Further, sliding between the second region R2 and the first resistance application portion 33A is to occur, and sliding between the second region R2 and the second resistance application portion 33B is to be suppressed. Here, if a sequential behavior is explained with reference to FIG. 27, the mounting member 20 rotates in the circumferential direction in the case where the first region R1 is in contact with the first resistance application portion 33A (refer to a reference numeral 27A). Then, the sliding between the second region R2 and the first resistance application portion 33A occurs (refer to a reference numeral 27B), and the one side 11b of the article to be inspected 10 faces the left guide 32A side.

Then, the mounting member 20 moves to the facing position of the second resistance application portion 33B. When the second region R2 comes into contact with the second resistance application portion 33B, the sliding between the second region R2 and the second resistance application portion 33B is suppressed, and the mounting member 20 rotates in the circumferential direction (refer to a reference numeral 27C). Thereafter, the sliding between the first region R1 and the second resistance application portion 33B occurs (refer to a reference numeral 27D), and the other side 11a of the article to be inspected 10 faces the left guide 32A side. However, in the case of the configuration shown in FIG. 27, two different types of resistance application portions (first resistance application portion 33A, second resistance application portion 33B) having different characteristics are to be prepared, and thus the cost thereof increases. On the other hand, in the configuration according to the exemplary embodiment, the first resistance application portion 33A and the second resistance application portion 33B can be produced with the same material. Accordingly, it is possible to decrease the cost in the configuration according to the exemplary embodiment.

Note that, in the above-mentioned conveyance device 30, the mounting member 20 is brought into contact with the resistance application portion 33 by giving the placement surface 31A a slope in a width direction of the conveyance device 30. However, as mentioned below, the mounting member 20 can be brought into contact with the resistance application portion 33 by using the roll-shaped members 314.

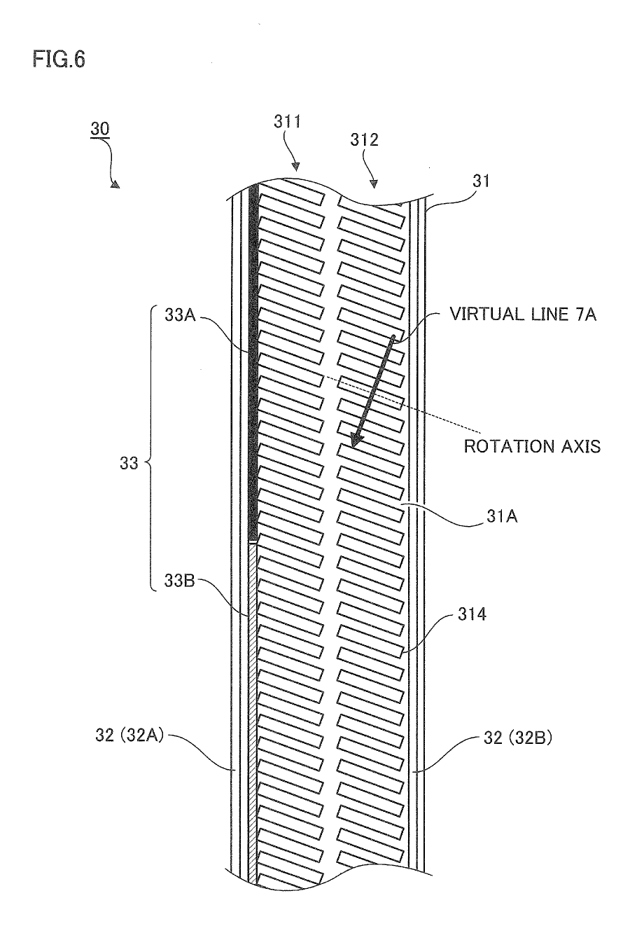

FIG. 6 is a view for showing another configuration of the conveyance device 30.

In the conveyance device 30 in this drawing, the slope in the width direction of the conveyance device 30 is not given to the placement surface 31A. Further, in the conveyance device 30 in the exemplary embodiment, the plural roll-shaped members 314 provided to the placement surface 31A are arranged to be inclined with respect to the front-back direction of the conveyance device 30.

Specifically, in the case where a virtual line (refer to a reference numeral 7A) orthogonal to the rotation axis of the roll-shaped members 314 is assumed to be set, each of the roll-shaped members 314 is arranged to be inclined so that the virtual line intersects with the front-back direction of the conveyance device 30. As an additional note, each of the roll-shaped members 314 is arranged so that the virtual line is inclined with respect to the front-back direction of the conveyance device 30. More specifically, each of the roll-shaped members 314 is arranged to be inclined so that the direction in which the aforementioned virtual line heads is the left guide 32A side. Accordingly, in the conveyance device 30 shown in FIG. 6, although the mounting member 20 tries to move toward the front side of the conveyance device 30, the mounting member 20 heads to the resistance application portion 33 by the roll-shaped members 314 arranged to be inclined. As an additional note, in the conveyance device 30 shown in FIG. 6, the roll-shaped members 314 guide the mounting member 20, and thereby contact between the resistance application portion 33 and the mounting member 20 is conducted.

In the above description, although the first region R1 to the third region R3 are formed by a coating material (ink, coating material) applied on the outer circumferential surface of the mounting member 20, the first region R1 to the third region R3 can be formed by attaching a seal member or a tape member onto the outer circumferential surface of the mounting member 20.

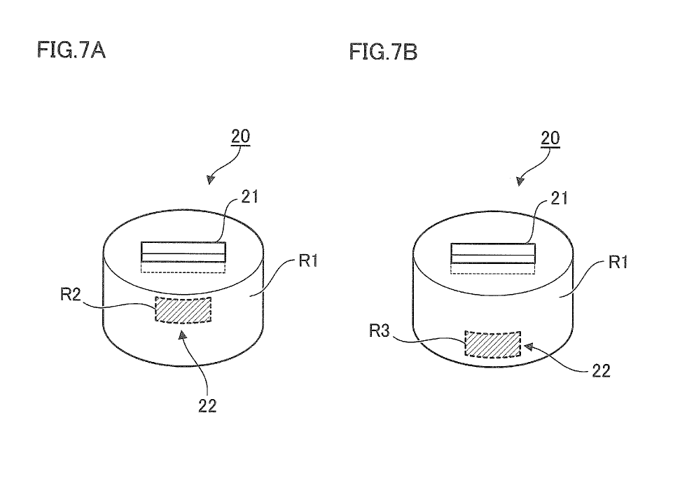

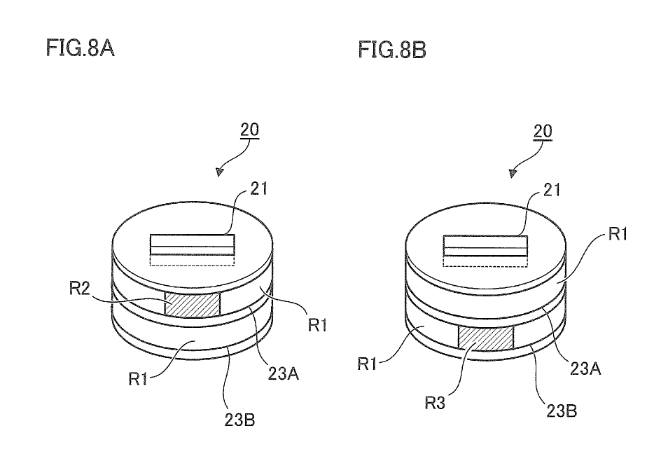

FIGS. 7A and 7B and FIGS. 8A and 8B are views for illustrating other configurations of the mounting member 20. Note that, FIG. 7A is an illustration of the mounting member 20 to which a seal member has been attached from one side, and FIG. 7B is an illustration of the mounting member 20 to which the seal member has been attached from the other side. Further, FIG. 8A is an illustration of the mounting member 20 to which a tape member has been attached from one side, and FIG. 8B is an illustration of the mounting member 20 to which the tape member has been attached from the other side.

The whole outer circumferential surface of the mounting member 20 shown in FIGS. 7A and 7B is formed by the aforementioned first region R1. Further, in the mounting member 20 shown in FIGS. 7A and 7B, the second region R2 and the third region R3 are formed by attaching, onto the outer circumferential surface, seal members 22 having a surface state similar to that of the second region R2. Further, in the mounting member 20 shown in FIGS. 8A and 8B, a first tape member 23A where the first region R1 and the second region R2 are formed by printing or the like and a second tape member 23B where the first region R1 and the third region R3 are formed by printing or the like are attached onto the outer circumferential surface of the mounting member 20. In this case, it is possible to attach the first region R1, the second region R2 and the third region R3 onto the outer circumferential surface of the mounting member 20 regardless of the coating state of the mounting member 20.

In the above description, the description has been given for the case where the two sides out of plural sides provided to the article to be inspected 10 are inspected. Hereinbelow, description will be given for the case where four sides are inspected.

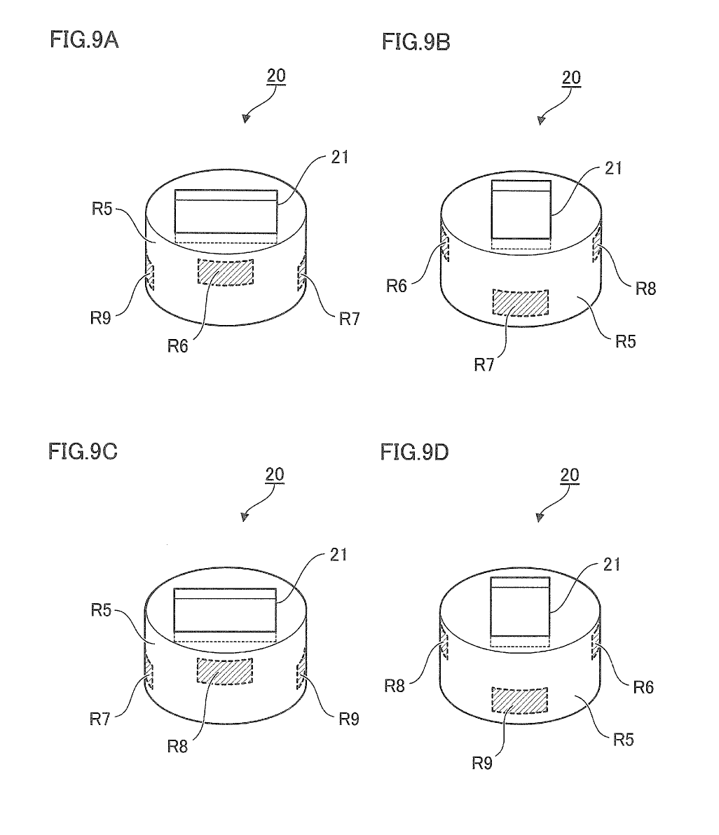

FIGS. 9A to 9D are views for showing furthermore configuration of the mounting member 20. Note that, FIG. 9A is a front view of the mounting member 20, FIG. 9B is a right side view of the mounting member 20, FIG. 9C is a back view of the mounting member 20, and FIG. 9D is a left side view of the mounting member 20.

The mounting member 20 in the exemplary embodiment has 5 regions which are a fifth region R5 to a ninth region R9 on the outer circumferential surface. Here, a sixth region R6 to the ninth region R9 are arranged to be shifted from each other by 90 degrees in the circumferential direction of the mounting member 20. Specifically, the sixth region R6 and an eighth region R8 are arranged to be shifted by 180 degrees, and a seventh region R7 and the ninth region R9 are arranged to be shifted by 180 degrees. Further, in the height direction of the mounting member 20, the sixth region R6 and the eighth region R8 are provided at the same position, and the seventh region R7 and the ninth region R9 are provided at the same position. Furthermore, the sixth region R6 and the eighth region R8 are provided above the seventh region R7 and the ninth region R9.

In the exemplary embodiment, the region other than the sixth region R6 to the ninth region R9 in the outer circumferential surface of the mounting member 20 is the fifth region R5. The sixth region R6 to the ninth region R9 are configured similarly to the aforementioned second region R2, and the fifth region R5 is configured similarly to the aforementioned first region R1. Further, in the exemplary embodiment, the sixth region R6 is formed on one region side having a boundary as the mounting portion 21, and the eighth region R8 is formed on the other side. Furthermore, the seventh region R7 is formed between the sixth region R6 and the eighth region R8. Still furthermore, the ninth region R9 is formed at the position located on the side opposite to the seventh region R7.

Here, the fifth region R5 is considered as another example of the first contact region or the first surface region, the sixth region R6 is considered as another example of the second contact region or the second surface region, the region located below the sixth region R6 is considered as another example of the third contact region or the third surface region, and the seventh region R7 is considered as another example of the fourth contact region or the fourth surface region. Further, the region located above the seventh region R7 is an example of a fifth contact region or a fifth surface region, the sixth region R8 is considered as an example of a sixth contact region or a sixth surface region, the region located below the sixth region R8 is considered as one example of a seventh contact region or a seventh surface region, and the ninth region R9 is considered as an example of an eighth contact region or an eighth surface region.

Next, description will be given for the conveyance device 30.

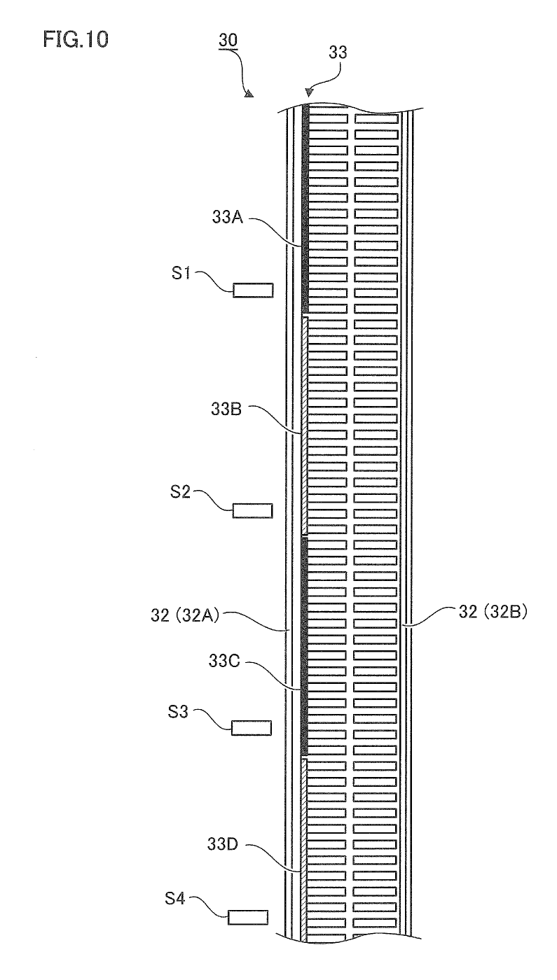

FIG. 10 is a view for illustrating the conveyance device 30 in the exemplary embodiment, and is a top view of the conveyance device 30. Note that, the conveyance device 30 in the exemplary embodiment has a configuration similar to that of the aforementioned conveyance device 30 except the resistance application portion 33. Here, the resistance application portion 33 in the exemplary embodiment has the first resistance application portion 33A and the second resistance application portion 33B similarly to the above. Further, in the exemplary embodiment, in addition to the first resistance application portion 33A and the second resistance application portion 33B, a third resistance application portion 33C (an example of a third resistance force application portion or a third contact portion) and a fourth resistance application portion 33D (an example of a fourth resistance force application portion or a fourth contact portion) are provided.

Here, the third resistance application portion 33C is arranged on the downstream side of the second resistance application portion 33B in the conveyance direction of the article to be inspected 10. The fourth resistance application portion 33D is arranged on the downstream side of the third resistance application portion 33C in the conveyance direction of the article to be inspected 10. Also, in the height direction of the conveyance device 30, the third resistance application portion 33C is arranged above the second resistance application portion 33B. As an additional note, the third resistance application portion 33C is arranged at a position having a height same as that of the first resistance application portion 33A. Further, the fourth resistance application portion 33D is arranged below the third resistance application portion 33C. As an additional note, the fourth resistance application portion 33D is arranged at a position having a height same as that of the second resistance application portion 33B.

In the exemplary embodiment, the first CCD camera S1 is arranged in the vicinity of the end of the first resistance application portion 33A on the downstream side, and the second CCD camera S2 is arranged in the vicinity of the end of the second resistance application portion 33B on the downstream side. Further, a third CCD camera S3 is arranged in the vicinity of the end of the third resistance application portion 33C on the downstream side, and a fourth CCD camera S4 is arranged in the vicinity of the end of the fourth resistance application portion 33D on the downstream side.

Next, description will be given for the behavior of the article to be inspected 10 and the mounting member 20 in the conveyance device 30.

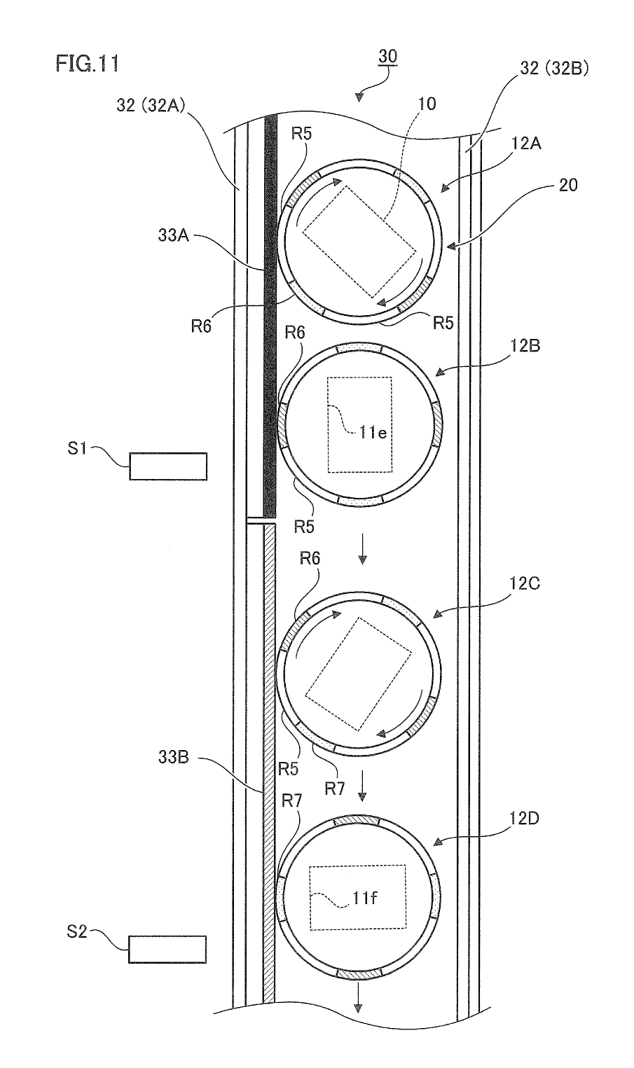

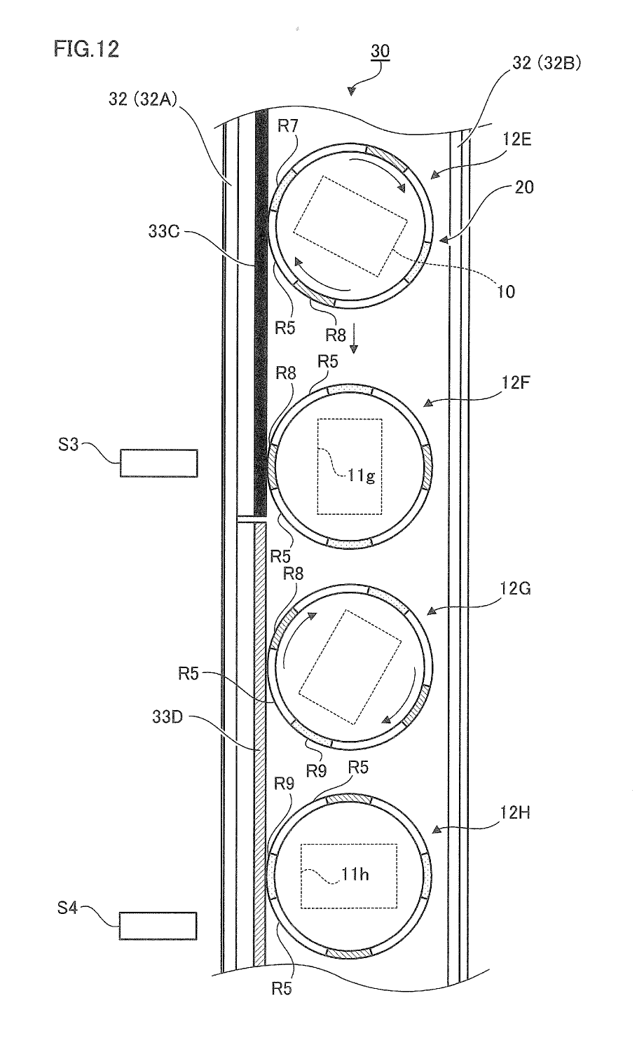

FIG. 11 and FIG. 12 are views for illustrating the behavior of the mounting member 20 in the conveyance device 30. Note that, also in these drawings, illustrations of the first roller array 311, the second roller array 312 and the like are omitted.

As the article to be inspected 10 where the mounting member 20 has been mounted is supplied to the conveyance device 30, the article to be inspected 10 moves frontward while being guided by the left guide 32A (first resistance application portion 33A), as indicated by a reference numeral 12A in FIG. 11. At this time, if the fifth region R5 is in contact with the first resistance application portion 33A for example, the mounting member 20 moves frontward while rotating in the clockwise direction (refer to the reference numeral 12A). Then, when the sixth region R6 (also refer to FIG. 9A) comes into contact with the first resistance application portion 33A, the mounting member 20 stops rotating (refer to a reference numeral 12B). Thereby, a first side 11e out of the four sides formed on the article to be inspected 10 faces the left guide 32A side. Further, the first side 11 e is captured by the first CCD camera S1.

Thereafter, along with the movement of the mounting member 20 (article to be inspected 10), the region located below the sixth region R6, which is contained in the fifth region R5 (refer to FIG. 9A), comes into contact with the second resistance application portion 33B. Thereby, the mounting member 20 moves frontward while rotating in the clockwise direction (refer to a reference numeral 12C). Then, when the seventh region R7 (also refer to FIG. 9B) comes into contact with the second resistance application portion 33B, the mounting member 20 stops rotating (refer to a reference numeral 12D). Thereby, a second side 11f out of the four sides on the article to be inspected 10 faces the left guide 32A side. Further, the second side 11f is captured by the second CCD camera S2.

Thereafter, along with the movement of the mounting member 20 (article to be inspected 10), the region located above the seventh region S7, which is contained in the fifth region R5 (refer to FIG. 9B), comes into contact with the third resistance application portion 33C. Thereby, the mounting member 20 moves frontward while rotating in the clockwise direction (refer to a reference numeral 12E in FIG. 12). Then, when the eighth region R8 (also refer to FIG. 9C) comes into contact with the third resistance application portion 33C as indicated by a reference numeral 12F, the mounting member 20 stops rotating. Thereby, a third side 11g out of the four sides on the article to be inspected 10 faces the left guide 32A side. Further, the third side 11g is captured by the third CCD camera S3.

After that, in the exemplary embodiment, along with the sliding movement of the mounting member 20 (article to be inspected 10), the region located below the eighth region R8, which is contained in the fifth region R5 (refer to FIG. 9C), comes into contact with the fourth resistance application portion 33D. Thereby, the mounting member 20 moves frontward while rotating in the clockwise direction (refer to a reference numeral 12G). Then, when the ninth region R9 (also refer to FIG. 9D) comes into contact with the fourth resistance application portion 33D as indicated by a reference numeral 12H, the mounting member 20 stops rotating. Thereby, a fourth side 11h out of the four sides on the article to be inspected 10 faces the left guide 32A side. Further, the fourth side 11h is captured by the fourth CCD camera S4. Note that, the article to be inspected 10 and the mounting member 20 further move frontward, and reach the next inspection process (not shown), similarly to the above.

### Second Exemplary Embodiment

Next, description will be given for the second exemplary embodiment.

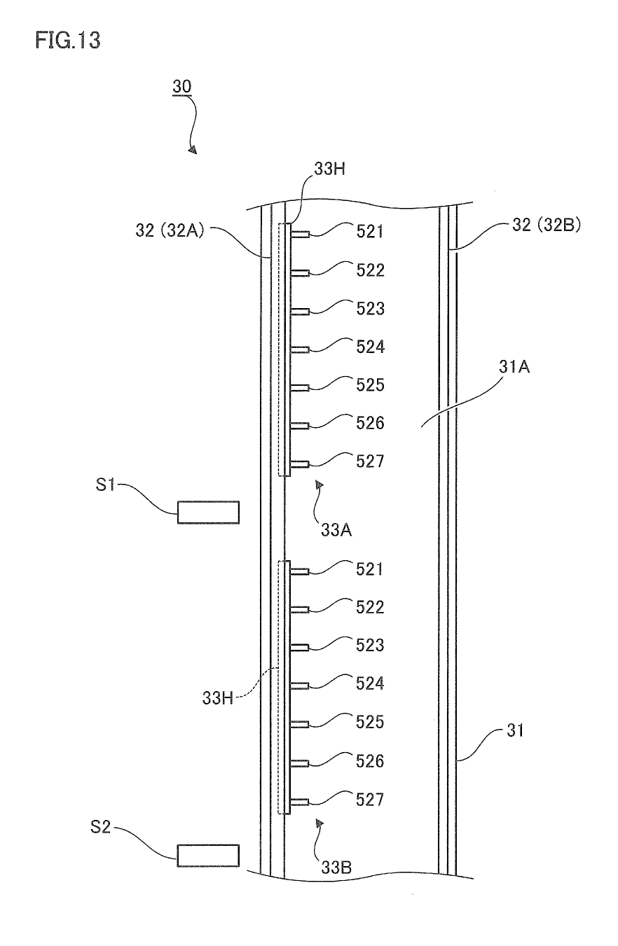

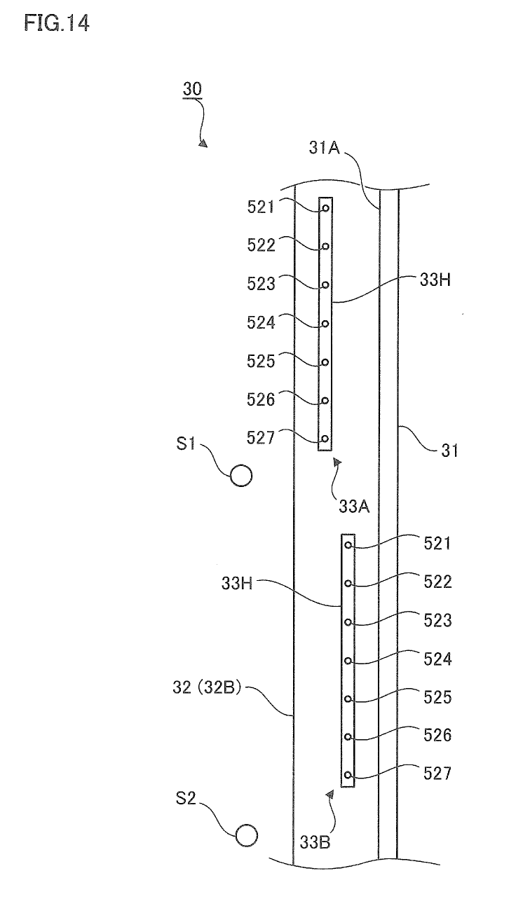

FIG. 13 is a top view of the conveyance device 30 in the second exemplary embodiment. FIG. 14 is a right side view of the conveyance device 30. Note that, same reference numerals are used for the functions similar to those in the first exemplary embodiment, and the description thereof is omitted here.

Also in the conveyance device 30 in the exemplary embodiment, the first resistance application portion 33A and the second resistance application portion 33B are provided similarly to the above. Here, similarly to the first exemplary embodiment, the first resistance application portion 33A is arranged on the upstream side of the second resistance application portion 33B in the conveyance direction of the article to be inspected 10. Also, in the height direction of the conveyance device 30, the first resistance application portion 33A is arranged above the second resistance application portion 33B.

Here, each of the first resistance application portion 33A and the second resistance application portion 33B has a prismatic base 33H embedded in a groove formed in the left guide 32A, and a first pin 521 to a seventh pin 527 as an example of projection portions which are attached to the base 33H and project from the base 33H toward the conveyance route of the article to be inspected 10. Here, in the exemplary embodiment, the first pin 521 is arranged on the most upstream side, and the seventh pin 527 is arranged on the most downstream side in the conveyance direction of the article to be inspected 10.

Next, description will be given for the mounting member 20.

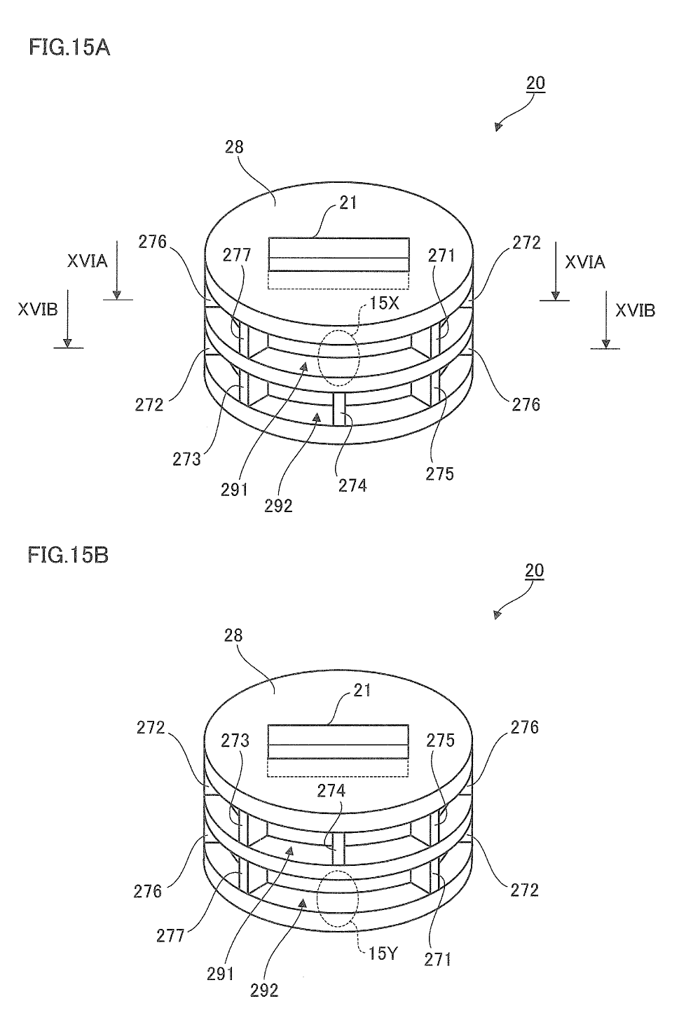

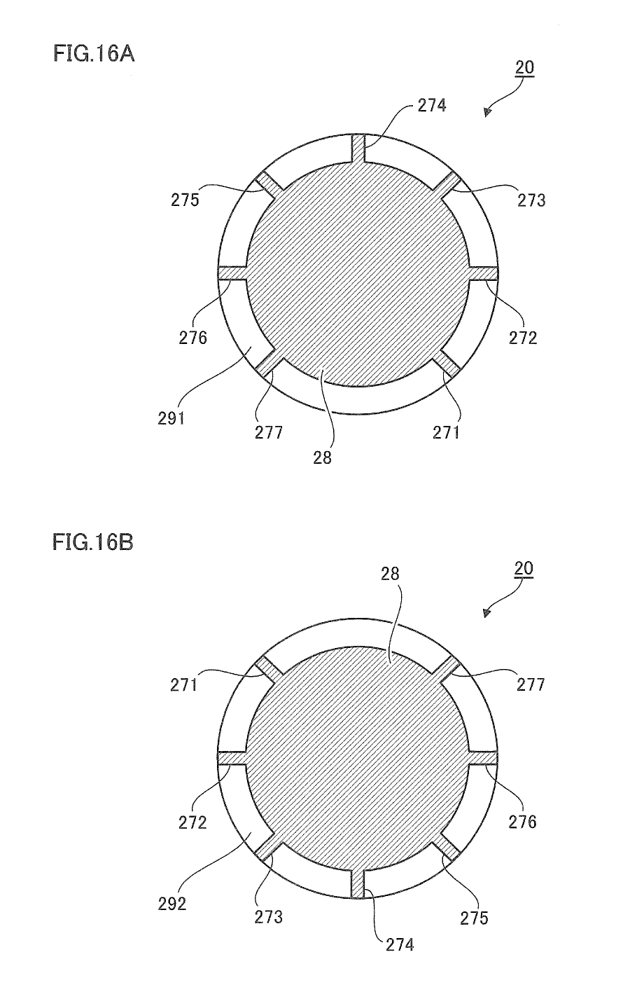

FIGS. 15A and 15B are perspective views of the mounting member 20. In detail, FIG. 15A is a perspective view when the mounting member 20 is seen from one side, and FIG. 15B is a perspective view when the mounting member 20 is seen from the other side. FIGS. 16A and 16B are cross-sectional views of the mounting member 20. In detail, FIG. 16A is a view for showing the cross-section taken along a line XVIA-XVIA in FIG. 15A, and FIG. 16B is a view for showing the cross-section taken along a line XVIB-XVIB in FIG. 15A.

In the mounting member 20 in the exemplary embodiment, a first groove 291 and a second groove 292 formed along the circumferential direction of the mounting member 20 are formed on the outer circumferential surface of the mounting member 20. Here, the first groove 291 is provided above the second groove 292. Further, in the inside of the first groove 291, a first protrusion 271 to a seventh protrusion 277 that protrude from the outer circumferential surface of a main body 28 of the mounting member toward the diameter direction of the mounting member 20 are provided. Here, these protrusions are provided at every 45 degrees in the circumferential direction of the mounting member 20. Further, these protrusions each have the upper end and the lower end respectively connected to the upper surface and the lower surface of the first groove 291. Furthermore, these protrusions are provided within a predetermined range in the circumferential direction of the mounting member 20. Here, the first protrusion 271 to the seventh protrusion 277 are considered as first contact portions.

In the exemplary embodiment, the protrusion is not provided on one side in the case where the mounting portion 21 is sandwiched between the one side and the other side. As an additional note, no protrusion is provided in a part indicated by a reference numeral 15X in FIG. 15A. Specifically, in the case where the protrusions are provided at every 45 degrees, 8 protrusions should be provided in total. However, in the exemplary embodiment, one protrusion out of them is omitted, and 7 protrusions are provided. More specifically, in the circumferential direction of the mounting member 20, a region where no protrusion is provided (an example of a first region or a first section) exists at a portion adjacent to a section where the aforementioned first protrusion 271 to seventh protrusion 277 are provided.

Note that, the inside of the second groove 292 is also configured similarly to the first groove 291, and the first protrusion 271 to the seventh protrusion 277 are provided in the inside of the second groove 292 similarly to the first groove 291. Here, these protrusions are also provided at every 45 degrees in the circumferential direction of the mounting member 20. Also, these protrusions each have the upper end and the lower end respectively connected to the upper surface and the lower surface of the second groove 292. Further, these protrusions are provided within a predetermined range in the circumferential direction of the mounting member 20. Here, the first protrusion 271 to the seventh protrusion 277 provided in the inside of the second groove 292 are considered as second contacting portions.

In the inside of the second groove 292, the protrusion is not provided on the other side in the case where the mounting portion 21 is sandwiched between the one side and the other side. As an additional note, although no protrusion is provided on the one side bordered by the mounting portion 21 in the inside of the aforementioned first groove 291, no protrusion is provided on the other side bordered by the mounting portion 21 in the inside of the second groove 292. More specifically, no protrusion is provided in a part indicated by a reference numeral 15Y in FIG. 15B. Still furthermore specifically, in the circumferential direction of the mounting member 20, a region where no protrusion is provided (an example of a second region or a second section) exists at a portion adjacent to a section where the aforementioned first protrusion 271 to seventh protrusion 277 are provided.

Next, description will be given for the behavior of the article to be inspected 10 (mounting member 20) in the conveyance device 30.

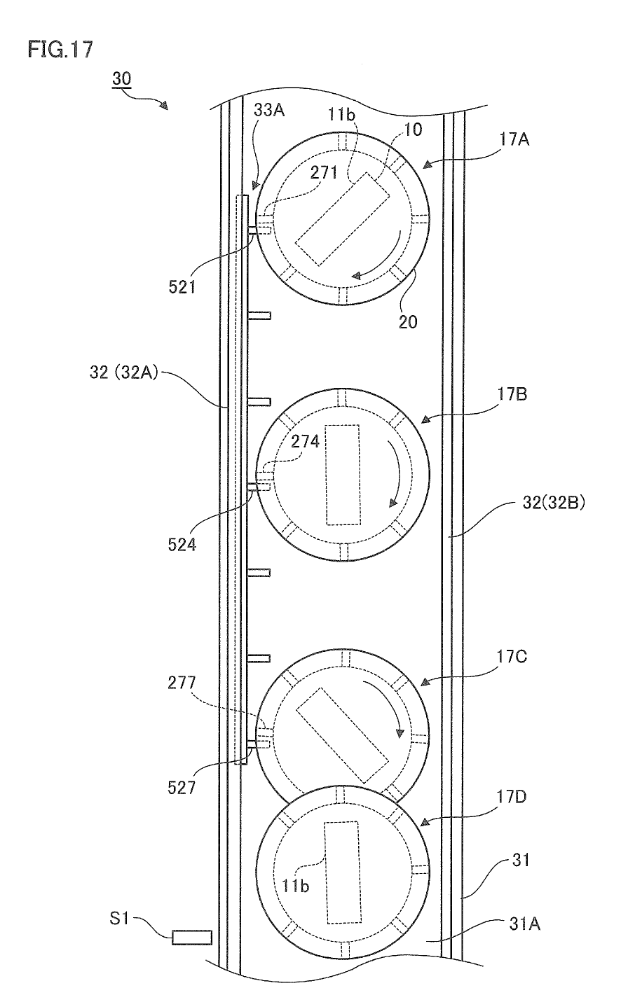

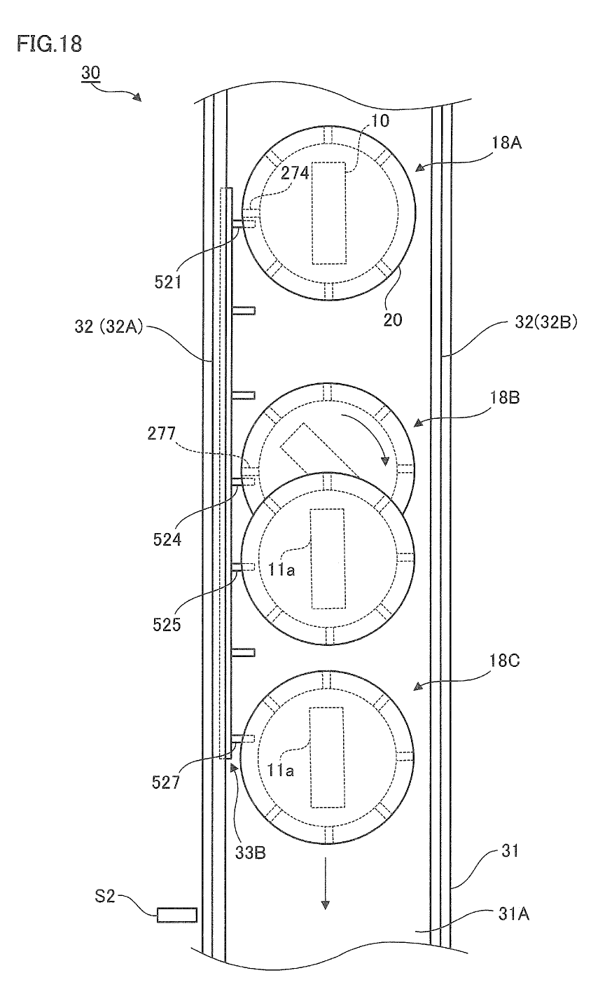

FIG. 17 and FIG. 18 are views for showing the behavior of the article to be inspected 10 (mounting member 20) in the conveyance device 30. As indicated by a reference numeral 17A in FIG. 17, in the case where the article to be inspected 10 and the mounting member 20 are supplied to the conveyance device 30 in the state where the one side 11b of the article to be inspected 10 faces the diagonally back side of the conveyance device 30 for example, the first protrusion 271 provided in the aforementioned first groove 291 bumps into the first pin 521 of the first resistance application portion 33A along with the movement of the article to be inspected 10. Thereby, the mounting member 20 rotates in the clockwise direction as indicated by a reference numeral 17A.

Next, in the exemplary embodiment, a second protrusion 272 bumps into a second pin 522, a third protrusion 273 bumps into a third pin 523, a fourth protrusion 274 bumps into a fourth pin 524 (refer to a reference numeral 17B), a fifth protrusion 275 bumps into a fifth pin 525, a sixth protrusion 276 bumps into a sixth pin 526, and thereby the mounting member 20 rotates in sequence. Finally, as indicated by a reference numeral 17C, the seventh protrusion 277 bumps into the seventh pin 527, and thereby the mounting member 20 rotates and the one side 11b of the article to be inspected 10 faces the left guide 32A side. Further, similarly to the above, the one side 11b is captured by the first CCD camera S1.

Thereafter, the article to be inspected 10 (mounting member 20) moves to the facing position of the second resistance application portion 33B as indicated by a reference numeral 18A in FIG. 18. When the mounting member 20 reaches the facing position of the second resistance application portion 33B, the fourth protrusion 274 provided in the inside of the second groove 292 (refer to FIG. 15A) bumps into the first pin 521 of the second resistance application portion 33B as indicated by a reference numeral 18A in FIG. 18. Thereby, the mounting member 20 rotates in the clockwise direction. As an additional note, the rotation of the mounting member 20 restarts. Here, if the second resistance application portion 33B is provided at a position corresponding to the first groove 291, further rotation of the mounting member 20 is difficult to be achieved since the protrusion bumping into the first pin 521 to the seventh pin 527 provided in the second resistance application portion 33B does not exist in the inside of the first groove 291. To avoid this, in the exemplary embodiment, the second resistance application portion 33B is arranged to be shifted to the lower side, the protrusions bumping into the first pin 521 to the seventh pin 527 provided to the second resistance application portion 33B are provided to the mounting member 20, and thereby further rotation of the mounting member 20 can be achieved.

Next, the fifth protrusion 275 bumps into the second pin 522, the sixth protrusion 276 bumps into the third pin 523, and the seventh protrusion 277 bumps into the fourth pin 524 as indicated by a reference numeral 18B. Thereby the other side 11a of the article to be inspected 10 faces the left guide 32A side. Note that, at this time, the section where no protrusion is provided in the mounting member 20 (refer to the reference numeral 15Y in FIG. 15B) faces the side where the second resistance application portion 33B is provided. Accordingly, the mounting member 20 moves frontward without rotation. In this case, similarly to the above, the aforementioned other side 11 a of the article to be inspected 10 is captured by the second CCD camera S2.

Note that, the mounting member 20 and the conveyance device 30 can be configured as follows.

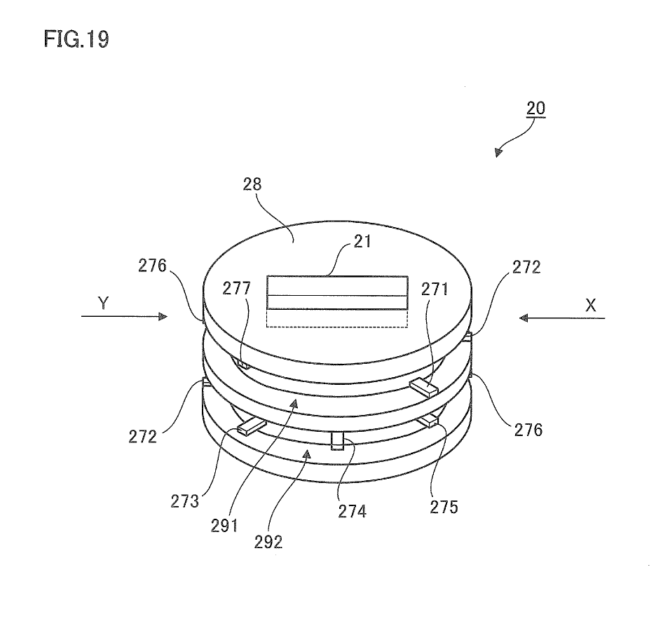

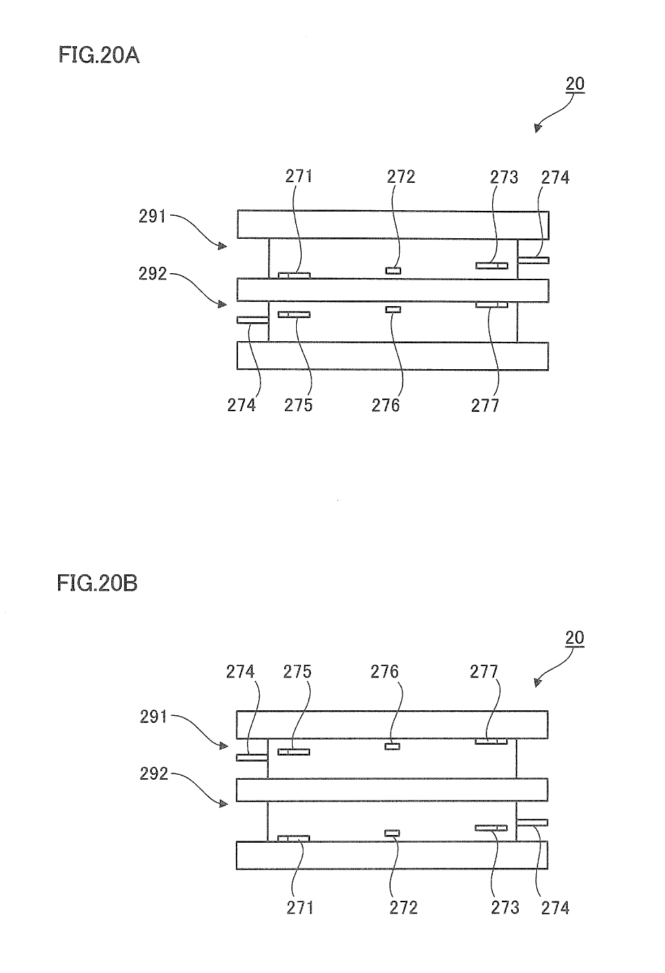

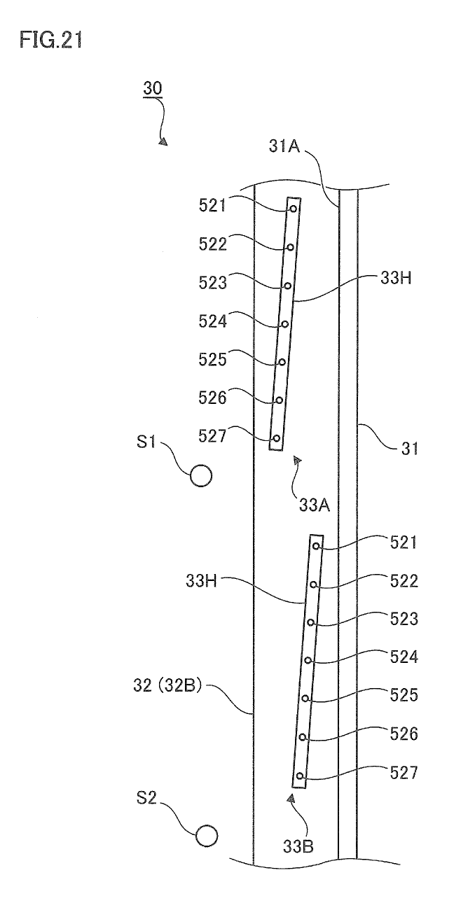

FIG. 19 and FIGS. 20A and 20B are views for illustrating another configuration of the mounting member 20. FIG. 21 is a view for showing another configuration of the conveyance device 30. Note that, FIG. 19 is a perspective view of the mounting member 20. FIG. 20A is a view of the mounting member 20 seen from an arrow X direction in FIG. 19, and FIG. 20B is a view of the mounting member 20 seen from an arrow Y direction in FIG. 19.

In the mounting member 20 in the exemplary embodiment, the length of the first protrusion 271 to the seventh protrusion 277 (length in the height direction of the mounting member 20) is shorter than the length of the first protrusion 271 to the seventh protrusion 277 shown in FIGS. 15A and 15B. Further, the first protrusion 271 to the seventh protrusion 277 are arranged to be shifted from each other in the height direction of the mounting member 20. As an additional note, the first protrusion 271 to the seventh protrusion 277 are arranged at respective positions different from each other in the height direction of the mounting member 20. Note that, the positions of the first protrusion 271 to the seventh protrusion 277 in the circumferential direction of the mounting member 20 are similar to the positions shown in FIGS. 15A and 15B.

Next, description will be given for the conveyance device 30 with reference to FIG. 21 (view for illustrating another configuration of the conveyance device 30). In the conveyance device 30 in the exemplary embodiment, the first pin 521 to the seventh pin 527 are arranged to be shifted from each other in the height direction of the conveyance device 30. Specifically, in the exemplary embodiment, the base 33H supporting the first pin 521 to the seventh pin 527 is arranged to be inclined with respect to the placement surface 31A, and thus the first pin 521 to the seventh pin 527 are arranged to be shifted from each other in the height direction of the conveyance device 30. Note that, in the exemplary embodiment, the base 33H is inclined to be separated from the placement surface 31A as the base 33H approaches to the front side of the conveyance device 30, the first pin 521 is arranged to be the nearest from the placement surface 31A, and the seventh pin 527 is arranged at a position farthest from the placement surface 31A.

Next, description will be given for the behavior of the mounting member 20 (article to be inspected 10) in the conveyance device 30.

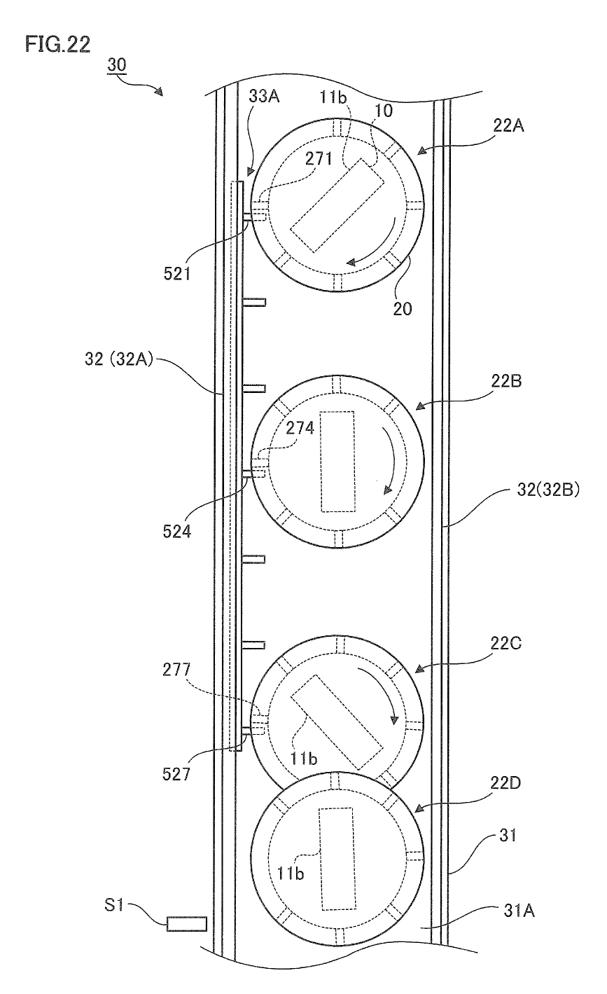

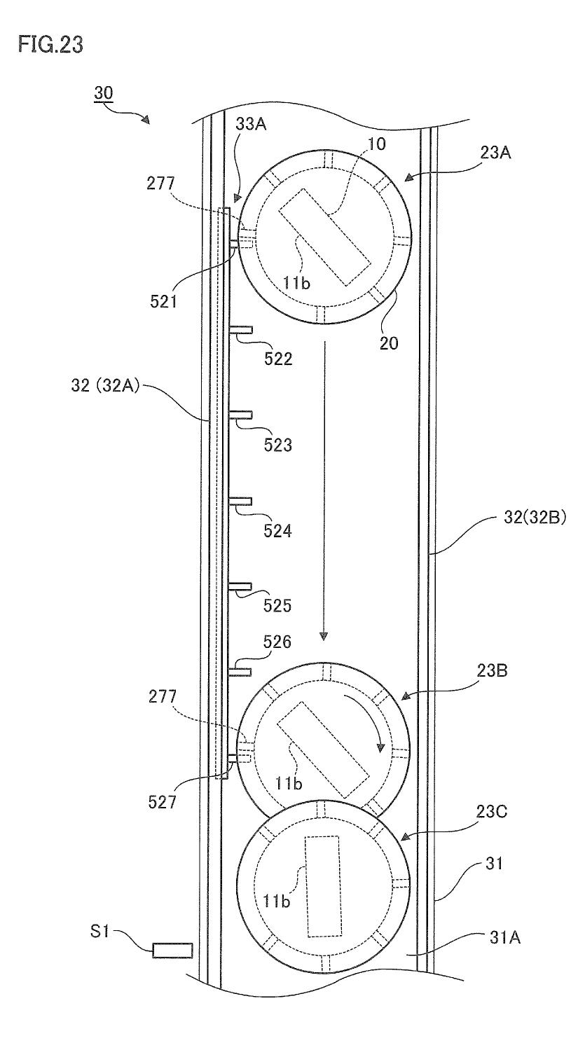

FIG. 22 and FIG. 23 are views for showing the behavior of the mounting member 20 (article to be inspected 10) in the conveyance device 30. For example, as indicated by a reference numeral 22A in FIG. 22, in the case where the article to be inspected 10 and the mounting member 20 are supplied to the conveyance device 30 in the state where the one side 11b of the article to be inspected 10 faces the diagonally back side of the conveyance device 30 for example, the first protrusion 271 provided in the inside of the first groove 291 bumps into the first pin 521 of the first resistance application portion 33A, similarly to the above. Thereby, the mounting member 20 rotates in the clockwise direction.

Also, as similarly to the above, the second protrusion 272 bumps into the second pin 522, the third protrusion 273 bumps into the third pin 523, the fourth protrusion 274 bumps into the fourth pin 524 (refer to a reference numeral 22B), the fifth protrusion 275 bumps into the fifth pin 525, the sixth protrusion 276 bumps into the sixth pin 526, and thereby the mounting member 20 rotates in series. Finally, as indicated by a reference numeral 22C, the seventh protrusion 277 bumps into the seventh pin 527, and thereby the mounting member 20 rotates and the one side 11b of the article to be inspected 10 faces the left guide 32A side. Further, similarly to the above, the one side 11b is captured by the first CCD camera S1.

For example, as indicated by a reference numeral 23A in FIG. 23, in the case where the one side 11b of the article to be inspected 10 is supplied to the conveyance device 30 in the state where the one side 11b of the article to be inspected 10 faces the diagonally forward left side of the conveyance device 30 for example, the seventh protrusion 277 provided in the inside of the first groove 291 is located on the side where the first resistance application portion 33A is provided. In this case, the seventh protrusion 277 passes through a section above the first pin 521 to the sixth pin 526 (also refer to FIG. 21) without bumping into these pins, and reaches the seventh pin 527 (refer to a reference numeral 23B). Then, the seventh protrusion 277 bumps into the seventh pin 527, and thereby the mounting member 20 rotates in the circumferential direction and the one side 11b of the article to be inspected 10 faces the left guide 32A side. Further, similarly to the above, the one side 11b is captured by the first CCD camera S1. Thereafter, the article to be inspected 10 and the mounting member 20 reach the facing position of the second resistance application portion 33B, similarly to the above. In this case, the fourth protrusion 274 provided in the second groove 292 bumps into the fourth pin 524 (refer to FIG. 21) in the second resistance application portion 33B, and rotation of the mounting member 20 restarts. Then, the fifth protrusion 275, the sixth protrusion 276, and the seventh protrusion 277 bump into the fifth pin 525, the sixth pin 526 and the seventh pin 527, respectively, and thereby the other side 11a of the article to be inspected 10 faces the left guide 32A side.

Next, description will be given for the mounting member 20 used at the inspection for the four sides of the article to be inspected 10.

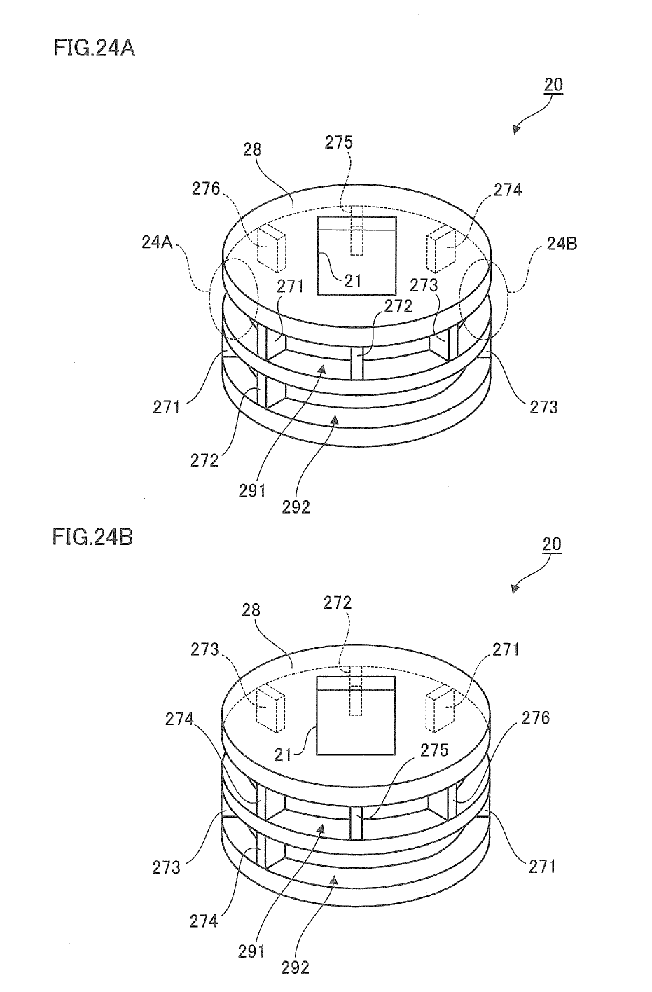

FIGS. 24A and 24B are views for illustrating furthermore configuration of the mounting member 20. Note that, FIG. 24A is an illustration of the mounting member 20 from one side, and FIG. 24B is an illustration of the mounting member 20 from the other side.

Here, in the mounting member 20 in the exemplary embodiment, six protrusions which are the first protrusion 271 to the sixth protrusion 276 are provided in the inside of the first groove 291. Here, the first protrusion 271 to the third protrusion 273 are arranged at 45 degree intervals in the circumferential direction of the mounting member 20, and are arranged on the front side of the mounting member 20 in FIG. 24A. Further, the fourth protrusion 274 to the sixth protrusion 276 are arranged at 45 degree intervals in the circumferential direction of the mounting member 20, and are arranged on the rear side of the mounting member 20 in FIG. 24A. Note that, in the exemplary embodiment, the protrusions protruding toward the right side and the left side in the figure, respectively, are not provided in the inside of the first groove 291. As an additional note, in regions indicated by reference numerals 24A and 24B, no protrusion is provided.

Further, in the mounting member 20 in the exemplary embodiment, four protrusions that are the first protrusion 271 to the fourth protrusion 274 are provided in the inside of the second groove 292. Here, the first protrusion 271 is provided below the region indicated by the aforementioned reference numeral 24A. The second protrusion 272 is arranged below the first protrusion 271 provided in the inside of the first groove 291. The third protrusion 273 is provided below the region indicated by the aforementioned reference numeral 24B. The fourth protrusion 274 is arranged below the fourth protrusion 274 provided in the inside of the first groove 291.

Next, description will be given for the behavior of the mounting member 20 (article to be inspected 10) in the conveyance device 30.

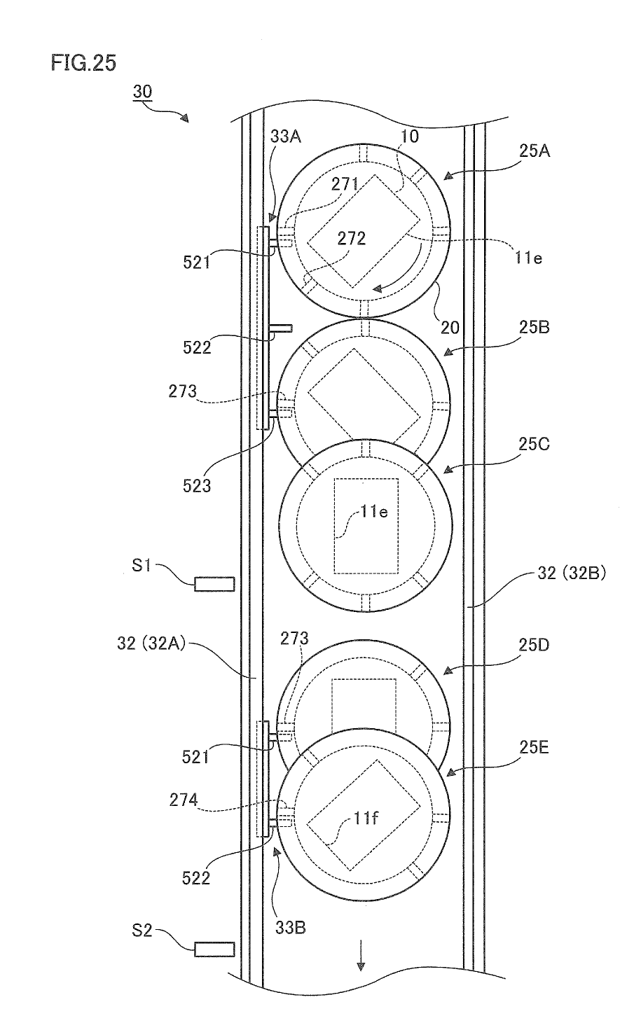

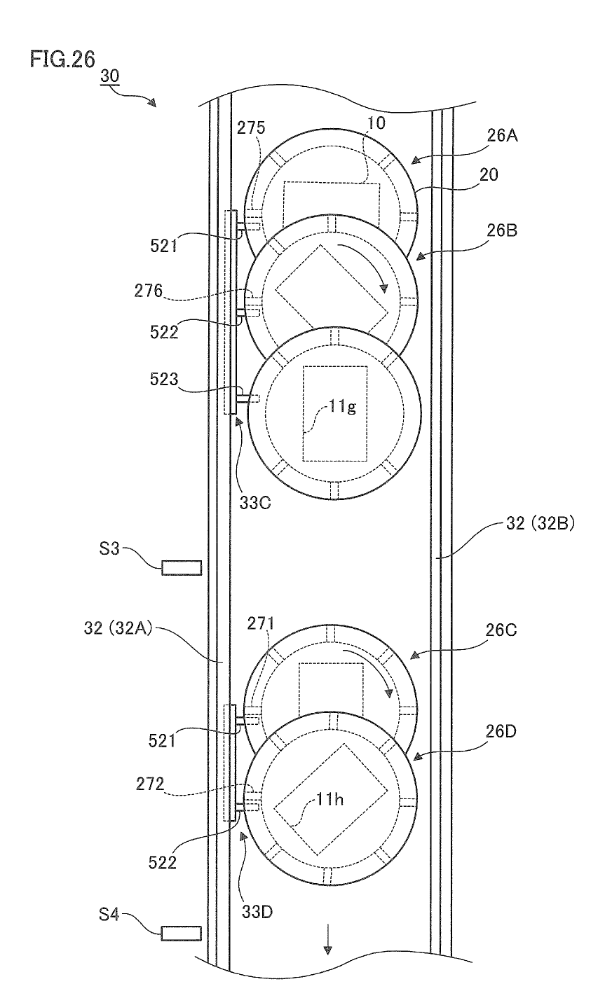

FIG. 25 and FIG. 26 are views for showing the behavior of the mounting member 20 (article to be inspected 10) in the conveyance device 30. For example, as indicated by a reference numeral 25A in FIG. 25, in the case where the article to be inspected 10 and the mounting member 20 are supplied to the conveyance device 30 in the state where the first side 11e out of the four sides formed on the article to be inspected 10 faces the diagonally forward right side of the conveyance device 30, the first protrusion 271 provided to the first groove 291 firstly bumps into the first pin 521 provided to the first resistance application portion 33A. Thereby, the mounting member 20 and the article to be inspected 10 rotate in the circumferential direction. Then, the second protrusion 272 bumps into the second pin 522, the third protrusion 273 bumps into the third pin 523 as indicated by a reference numeral 25B, and thereby the mounting member 20 further rotates in the circumferential direction. Thereby, the first side 11e of the article to be inspected 10 faces the left guide 32A side, and the first side 11e is captured by the first CCD camera S1.

Thereafter, the article to be inspected 10 and the mounting member 20 reach the facing position of the second resistance application portion 33B as indicated by a reference numeral 25D in this drawing. In this case, as indicated by the reference numeral 25D, the third protrusion 273 (also refer to FIG. 24B) provided in the inside of the second groove 292 bumps into the first pin 521 of the second resistance application portion 33B. Thereby, the mounting member 20 and the article to be inspected 10 rotate in the clockwise direction. As an additional note, the mounting member 20 and the article to be inspected 10 rotate again. Subsequently, the fourth protrusion 274 bumps into the second pin 522 provided in the second resistance application portion 33B, and the mounting member 20 rotates in the circumferential direction. Thereby, the second side 11f of the article to be inspected 10 faces the left guide 32A side and is captured by the second CCD camera S2.

Thereafter, the article to be inspected 10 and the mounting member 20 reach the facing position of the third resistance application portion 33C, as indicated by a reference numeral 26A in FIG. 26. In this case, as indicated by the reference numeral 26A, the fifth protrusion 275 (also refer to FIG. 24B) provided in the inside of the first groove 291 bumps into the first pin 521 of the third resistance application portion 33C. Thereby, the mounting member 20 and the article to be inspected 10 rotate in the clockwise direction. Subsequently, the sixth protrusion 276 bumps into the second pin 522 provided to the third resistance application portion 33C (refer to a reference numeral 26B), and the mounting member 20 rotates in the circumferential direction. Thereby, the third side 11g of the article to be inspected 10 faces the left guide 32A side and is captured by the third CCD camera S3.

Thereafter, the article to be inspected 10 and the mounting member 20 reach the facing position of the fourth resistance application portion 33D as indicated by a reference numeral 26C in FIG. 26. In this case, as indicated by the reference numeral 26C, the first protrusion 271 (also refer to FIG. 24A) provided in the inside of the second groove 292 bumps into the first pin 521 of the fourth resistance application portion 33D. Thereby, the mounting member 20 and the article to be inspected 10 rotate in the clockwise direction. Subsequently, the second protrusion 272 bumps into the second pin 522 provided to the fourth resistance application portion 33D (refer to a reference numeral 26D), and the mounting member 20 rotates in the circumferential direction. Thereby, the fourth side 11h of the article to be inspected 10 faces the left guide 32A side and is captured by the fourth CCD camera S4.

Note that, in the aforementioned first and second exemplary embodiments, the article to be inspected 10 and the mounting member 20 are conveyed by using the roll-shaped members 314 that are driven to be rotated by the motor M (refer to FIG. 2A). However, if a slope descending toward the downstream side in the conveyance direction is given to the placement unit 31, the article to be inspected 10 and the mounting member 20 can be conveyed by using the slope. Alternatively, the roll-shaped members 314 contained in the second roller array 312 (refer to FIG. 2A) can be fixed not to be rotated. In the case of fixing them, resistance force for suppressing the rotation is given to the mounting member 20, and excessive rotation of the mounting member 20 is suppressed. As an additional note, resistance force for suppressing the rotation is given to the mounting member 20, and occurrence of a situation in which the mounting member 20 rotates even though the aforementioned second region R2 or third region R3 is in contact with the resistance application portion 33, for example, is suppressed.

Instead of rotating the roll-shaped members 314 in the first roller array 311 and the roll-shaped members 314 in the second roller array 312 at the same speed, the roll-shaped members 314 in the second roller array 312 are rotated slightly slower than the roll-shaped members 314 in the first roller array 311, and thereby excessive rotation of the mounting member 20 can be suppressed. Further, in the aforementioned first and second exemplary embodiments, the description has been given for the case where the article to be inspected 10 is rotated by using the mounting member 20. However, by forming the first region R1 and the second region R2 on the outer peripheral surface of the article to be inspected 10 or the first protrusion 271 to the seventh protrusion 277 thereon, the article to be inspected 10 can be rotated without using the mounting member 20.

### REFERENCE SIGNS LIST

10 . . . Article to be inspected

20 . . . Mounting member

30 . . . Conveyance device

31 . . . Placement unit

33A . . . First resistance application portion

33B . . . Second resistance application portion

33C . . . Third resistance application portion

33D . . . Fourth resistance application portion

50 . . . Main body of mounting member

271 to 277 . . . First protrusion to seventh protrusion

521 to 527 . . . First pin to seventh pin

1. A conveyance system comprising:
an article; and
a conveyance device that conveys the article, wherein
the conveyance device comprises:
a conveyance unit that conveys the article along a predetermined conveyance route;
a first resistance force application portion that is arranged on a side of the conveyance route, and that comes into contact with an outer circumferential surface of the article to be conveyed in the conveyance route and applies resistance force to the article; and
a second resistance force application portion that is arranged on the side of the conveyance route and is arranged on a downstream side of the first resistance force application portion in a conveyance direction of the article and at a position different from the first resistance force application portion in a height direction, and that comes into contact with the outer circumferential surface of the article to be conveyed in the conveyance route and applies resistance force to the article, and
the article comprises:
a main body of the article that has the outer circumferential surface;
a first contact region that is provided on the outer circumferential surface of the main body of the article, and that rotates the main body of the article in a circumferential direction by using the resistance force applied by the first resistance force application portion when coming into contact with the first resistance force application portion;
a second contact region that is provided on the outer circumferential surface of the main body of the article, and that comes into contact with the first resistance force application portion along with the rotation caused by the contact between the first contact region and the first resistance force application portion and slides the main body of the article with respect to the first resistance force application portion to make sliding movement of the main body of the article;
a third contact region that is provided on the outer circumferential surface of the main body of the article, and that comes into contact with the second resistance force application portion along with the sliding movement and rotates the main body of the article in the circumferential direction by using the resistance force applied by the second resistance force application portion; and
a fourth contact region that is provided on the outer circumferential surface of the main body of the article, and that comes into contact with the second resistance force application portion along with the rotation caused by the contact between the third contact region and the second resistance force application portion and slides the main body of the article with respect to the second resistance force application portion to make sliding movement of the main body of the article.

2. The conveyance system according to claim 1, wherein
the second contact region is provided on one side of the main body of the article, and
the fourth contact region is provided on a side opposite to the side where the second contact region is provided.

3. The conveyance system according to claim 1, wherein
the article is configured with an inspection target object to which a predetermined inspection is conducted and a mounting member mounted on the inspection target object, and
the first contact region, the second contact region, the third contact region and the fourth contact region are formed on an outer circumferential surface of the mounting member.

4. The conveyance system according to claim 1, wherein
the conveyance device further comprises:
a third resistance force application portion that is arranged on the side of the conveyance route and is arranged on a downstream side of the second resistance force application portion in the conveyance direction of the article and at a position different from the second resistance force application portion in the height direction, and that comes into contact with the outer circumferential surface of the article to be conveyed in the conveyance route and applies resistance force to the article; and
a fourth resistance force application portion that is arranged on the side of the conveyance route and is arranged on a downstream side of the third resistance force application portion in the conveyance direction of the article and at a position different from the third resistance force application portion in the height direction, and that comes into contact with the outer circumferential surface of the article to be conveyed in the conveyance route and applies resistance force to the article, and
the article further comprises:
a fifth contact region that is provided on the outer circumferential surface of the main body of the article, and that comes into contact with the third resistance force application portion along with the sliding movement and rotates the main body of the article in the circumferential direction by using the resistance force applied by the third resistance force application portion;
a sixth contact region that is provided on the outer circumferential surface of the main body of the article, and that comes into contact with the third resistance force application portion along with the rotation caused by the contact between the fifth contact region and the third resistance force application portion and slides the main body of the article with respect to the third resistance force application portion to make sliding movement of the main body of the article;
a seventh contact region that is provided on the outer circumferential surface of the main body of the article, and that comes into contact with the fourth resistance force application portion along with the sliding movement and rotates the main body of the article in the circumferential direction by using the resistance force applied by the fourth resistance force application portion; and
an eighth contact region that is provided on the outer circumferential surface of the main body of the article, and that comes into contact with the fourth resistance force application portion along with the rotation caused by the contact between the seventh contact region and the fourth resistance force application portion and slides the main body of the article with respect to the fourth resistance force application portion to make sliding movement of the main body of the article.

5. The conveyance system according to claim 4, wherein the second contact region, the fourth contact region, the sixth contact region and the eighth contact region which slide the main body of the article are arranged to be shifted from each other by about 90 degrees in the circumferential direction of the main body of the article.

6. A conveyance device comprising:
a conveyance unit that conveys, along a predetermined conveyance route, an article having, on an outer circumferential surface, a first surface region and a second surface region which have different surface states and are provided to be adjacent to each other in a circumferential direction and a third surface region and a fourth surface region which have different surface states, which are provided to be adjacent to each other in the circumferential direction, and which are arranged at a position different from that of the first surface region and the second surface region in a height direction;
a first rotation and rotation stop unit that has a first contact portion coming into contact with the outer circumferential surface of the article to be conveyed in the conveyance route, that applies resistance force to the first surface region from the first contact portion and rotates the article in the circumferential direction in a case where the first surface region of the article comes into contact with the first contact portion, and that slides the second surface region with respect to the first contact portion and stops the rotation in a case where the second surface region of the article comes into contact with the first contact portion along with the rotation; and
a second rotation and rotation stop unit that has a second contact portion arranged on a downstream side of the first contact portion in a conveyance direction of the article, provided at a portion different from the first contact portion in the height direction and coming into contact with the outer circumferential surface of the article having been conveyed, that applies, from the second contact portion, resistance force to the third surface region of the article whose rotation has been stopped by the first rotation and rotation stop unit and rotates the article in the circumferential direction, and that slides the fourth surface region with respect to the second contact portion and stops the rotation in a case where the forth surface region comes into contact with the second contact portion along with the rotation.

7. The conveyance device according to claim 6, further comprising:
a third rotation and rotation stop unit that has a third contact portion arranged on a downstream side of the second contact portion in the conveyance direction of the article, provided at a portion different from the second contact portion in the height direction and coming into contact with the outer circumferential surface of the article having been conveyed, that applies, from the third contact portion, resistance force to a fifth surface region of the article whose rotation has been stopped by the second rotation and rotation stop unit and rotates the article in the circumferential direction, and that slides, with respect to the third contact portion, a sixth surface region adjacent to the fifth surface region and stops the rotation in a case where the sixth surface region comes into contact with the third contact portion along with the rotation; and
a fourth rotation and rotation stop unit that has a fourth contact portion arranged on a downstream side of the third contact portion in the conveyance direction of the article, provided at a portion different from the third contact portion in the height direction and coming into contact with the outer circumferential surface of the article having been conveyed, that applies, from the fourth contact portion, resistance force to a seventh surface region of the article whose rotation has been stopped by the third rotation and rotation stop unit and rotates the article in the circumferential direction, and that slides, with respect to the fourth contact portion, an eighth surface region adjacent to the seventh surface region and stops the rotation in a case where the eighth surface region comes into contact with the fourth contact portion along with the rotation.

8. An article that is capable of being conveyed by a conveyance device having a first contact portion coming into contact with an outer circumferential surface of a conveyed object conveyed in a conveyance route and a second contact portion provided on a downstream side of the first contact portion in a conveyance direction of the conveyed object, provided above or below the first contact portion and coming into contact with the outer circumferential surface of the conveyed object, the article comprising:
a main body of the article that has an outer circumferential surface;
a first contact region that is provided on the outer circumferential surface of the main body of the article, and that comes into contact with the first contact portion along with movement of the main body of the article in the conveyance device and rotates the main body of the article in a circumferential direction by using resistance force applied by the first contact portion;
a second contact region that is provided on the outer circumferential surface of the main body of the article, and that comes into contact with the first contact portion along with the rotation caused by the contact between the first contact region and the first contact portion and slides the main body of the article with respect to the first contact portion to make sliding movement of the main body of the article;
a third contact region that is provided on the outer circumferential surface of the main body of the article, and that comes into contact with the second contact portion along with the sliding movement and rotates the main body of the article in the circumferential direction by using resistance force applied by the second contact portion; and
a fourth contact region that is provided on the outer circumferential surface of the main body of the article, and that comes into contact with the second contact portion along with the rotation caused by the contact between the third contact region and the second contact portion and slides the main body of the article with respect to the second contact portion to make sliding movement of the main body of the article.

9. The article according to claim 8, wherein
the second contact region is provided on one side of the main body of the article, and
the fourth contact region is provided on a side opposite to the side where the second contact region is provided.

10. A conveyance system comprising:
an article; and
a conveyance device that conveys the article, wherein
the conveyance device comprises:
a conveyance unit that conveys the article along a predetermined conveyance route;
a first resistance force application portion that has a plurality of projection portions arranged at a plurality of positions in a conveyance direction of the article and projecting to the conveyance route, and that comes into contact with a side of the article to be conveyed in the conveyance route and applies resistance force to the article; and
a second resistance force application portion that has a plurality of projection portions arranged at a plurality of positions in the conveyance direction of the article and projecting to the conveyance route, that is arranged on a downstream side of the first resistance force application portion in the conveyance direction of the article and at a position different from the first resistance force application portion in a height direction, and that comes into contact with the side of the article to be conveyed in the conveyance route and applies resistance force to the article,
the article comprises:
a main body of the article;
a plurality of first contact portions that are arranged within a predetermined range in a circumferential direction of the main body of the article and are arranged in the circumferential direction, and that are capable of coming into contact with the plurality of projection portions provided in the first resistance force application portion;
a first region that is located at a portion adjacent to the predetermined range in the circumferential direction, and that does not have the plurality of first contact portions; and
a plurality of second contact portions that are arranged within a predetermined range in the circumferential direction of the main body of the article and are arranged in the circumferential direction, and that are capable of coming into contact with the plurality of projection portions provided in the second resistance force application portion; and
a second region that is located at a portion adjacent to the predetermined range where the plurality of second contact portions are provided, and that does not have the plurality of second contact portions, wherein
the plurality of first contact portions of the article moving in the conveyance route sequentially come into contact with the plurality of projection portions provided in the first resistance force application portion and thereby the article rotates in the circumferential direction, the first region faces a side where the plurality of projection portions are provided along with the rotation and thereby the rotation of the article stops, the plurality of second contact portions of the article sequentially come into contact with the plurality of projection portions provided in the second resistance force application portion and thereby rotation of the article restarts, and the second region faces a side where the plurality of projection portions are provided along with the rotation and thereby the rotation of the article stops.

11. The conveyance system according to claim 10, wherein
the first region is provided on one side of the main body of the article, and
the second region is provided on a side opposite to the side where the first region is provided.

12. The conveyance system according to claim 10, wherein
the article is configured with an inspection target object to which a predetermined inspection is conducted and a mounting member mounted on the inspection target object, and
the plurality of first contact portions, the first region, the plurality of second contact portions, and the second region are formed in the mounting member.

13. The conveyance system according to claim 10, wherein
the conveyance device further comprises:
a third resistance force application portion that has a plurality of projection portions arranged at a plurality of positions in the conveyance direction of the article and projecting to the conveyance route, that is arranged on a downstream side of the second resistance force application portion in the conveyance direction of the article and at a position different from the second resistance force application portion in the height direction, and that comes into contact with the side of the article to be conveyed in the conveyance route and applies resistance force to the article; and
a fourth resistance force application portion that has a plurality of projection portions arranged at a plurality of positions in the conveyance direction of the article and projecting to the conveyance route, that is arranged on a downstream side of the third resistance force application portion in the conveyance direction of the article and at a position different from the third resistance force application portion in the height direction, and that comes into contact with the side of the article to be conveyed in the conveyance route and applies resistance force to the article,
the article further comprises:
a plurality of third contact portions that are arranged within a predetermined range in the circumferential direction of the main body of the article and are arranged in the circumferential direction, and that are capable of coming into contact with the plurality of projection portions provided in the third resistance force application portion;
a third region that is located at a portion adjacent to the predetermined range where the plurality of third contact portions are provided, and that does not have the plurality of third contact portions;
a plurality of fourth contact portions that are arranged within a predetermined range in the circumferential direction of the main body of the article and are arranged in the circumferential direction, and that are capable of coming into contact with the plurality of projection portions provided in the fourth resistance force application portion; and
a fourth region that is located at a portion adjacent to the predetermined range where the plurality of fourth contact portions are provided, and that does not have the plurality of fourth contact portions, wherein
the plurality of third contact portions of the article sequentially come into contact with the plurality of projection portions provided in the third resistance force application portion and thereby rotation of the article restarts, the third region faces a side where the plurality of projection portions are provided along with the rotation and thereby the rotation of the article stops, the plurality of fourth contact portions of the article sequentially come into contact with the plurality of projection portions provided in the fourth resistance force application portion and thereby rotation of the article restarts, and the fourth region faces a side where the plurality of projection portions are provided along with the rotation and thereby the rotation of the article stops.

14. A conveyance device comprising:
a conveyance unit that conveys an article along a predetermined conveyance route;
a first resistance force application portion that has a plurality of projection portions arranged at a plurality of positions in a conveyance direction of the article and projecting to the conveyance route, and that comes into contact with a side of the article to be conveyed in the conveyance route and applies resistance force to the article; and
a second resistance force application portion that has a plurality of projection portions arranged at a plurality of positions in the conveyance direction of the article and projecting to the conveyance route, that is arranged on a downstream side of the first resistance force application portion in the conveyance direction of the article and at a position different from the first resistance force application portion in a height direction, and that comes into contact with the side of the article to be conveyed in the conveyance route and applies resistance force to the article.

15. The conveyance device according to claim 14, further comprising:
a third resistance force application portion that has a plurality of projection portions arranged at a plurality of positions in the conveyance direction of the article and projecting to the conveyance route, that is arranged on a downstream side of the second resistance force application portion in the conveyance direction of the article and at a position different from the second resistance force application portion in the height direction, and that comes into contact with the side of the article to be conveyed in the conveyance route and applies resistance force to the article; and
a fourth resistance force application portion that has a plurality of projection portions arranged at a plurality of positions in the conveyance direction of the article and projecting to the conveyance route, that is arranged on a downstream side of the third resistance force application portion in the conveyance direction of the article and at a position different from the third resistance force application portion in the height direction, and that comes into contact with the side of the article to be conveyed in the conveyance route and applies resistance force to the article.

16. An article that is capable of being conveyed by a conveyance device having a first resistance force application portion which has a plurality of projection portions projecting from a side of a conveyance route to the conveyance route, and which comes into contact with a side of a conveyed object to be conveyed in the conveyance route and applies resistance force to the conveyed object, and a second resistance force application portion which is arranged on a downstream side of the first resistance force application portion in a conveyance direction of the conveyed object and is arranged above or below the first resistance force application portion, which has a plurality of projection portions projecting from the side of the conveyance route to the conveyance route, and which comes into contact with the side of the conveyed object to be conveyed in the conveyance route and applies resistance force to the conveyed object, the article comprising:
a main body of the article;
a plurality of first contact portions that are arranged within a predetermined range in a circumferential direction of the main body of the article and are arranged in the circumferential direction, and that sequentially come into contact with the plurality of projection portions provided in the first resistance force application portion and rotate the main body of the article in the circumferential direction;
a first section that is located at a section adjacent to the predetermined range, that does not have the plurality of first contact portions, and that faces a side where the first resistance force application portion is provided along with the rotation and stops the rotation;
a plurality of second contact portions that are arranged within a predetermined range in the circumferential direction of the main body of the article and are arranged in the circumferential direction, and that sequentially come into contact with the plurality of projection portions provided in the second resistance force application portion along with movement of the main body of the article and rotate the main body of the article in the circumferential direction; and
a second section that is located at a section adjacent to the predetermined range where the plurality of second contact portions are provided, that does not have the plurality of second contact portions, and that faces a side where the second resistance force application portion is provided along with the rotation and stops the rotation.

17. The article according to claim 16, further comprising:
a plurality of third contact portions that are arranged within a predetermined range in the circumferential direction of the main body of the article and are arranged in the circumferential direction, and that sequentially come into contact with the plurality of projection portions provided in a third resistance force application portion arranged on a downstream side of the second resistance force application portion in the conveyance direction of the article and at a position different from the second resistance force application portion in a height direction and rotate the main body of the article in the circumferential direction;
a third section that is located at a section adjacent to the predetermined range where the plurality of third contact portions are provided, that does not have the plurality of third contact portions, and that faces a side where the third resistance force application portion is provided along with the rotation and stops the rotation;
a plurality of fourth contact portions that are arranged within a predetermined range in the circumferential direction of the main body of the article and are arranged in the circumferential direction, and that sequentially come into contact with the plurality of projection portions provided in a fourth resistance force application portion arranged on a downstream side of the third resistance force application portion in the conveyance direction of the article and at a position different from the third resistance force application portion in the height direction and rotate the main body of the article in the circumferential direction; and
a fourth section that is located at a section adjacent to the predetermined range where the plurality of fourth contact portions are provided, that does not have the plurality of fourth contact portions, and that faces a side where the fourth resistance force application portion is provided along with the rotation and stops the rotation.

18. An inspection system comprising:
an article;
a conveyance device that conveys the article; and
an inspection unit that inspects the article to be conveyed by the conveyance device, wherein
the conveyance device comprises:
a conveyance unit that conveys the article along a predetermined conveyance route;
a first resistance force application portion that is arranged on a side of the conveyance route, and that comes into contact with an outer circumferential surface of the article to be conveyed in the conveyance route and applies resistance force to the article; and
a second resistance force application portion that is arranged on the side of the conveyance route and is arranged on a downstream side of the first resistance force application portion in a conveyance direction of the article and at a position different from the first resistance force application portion in a height direction, and that comes into contact with the outer circumferential surface of the article to be conveyed in the conveyance route and applies resistance force to the article, and
the article comprises:
a main body of the article that has the outer circumferential surface:
a first contact region that is provided on the outer circumferential surface of the main body of the article, and that rotates the main body of the article in a circumferential direction by using the resistance force applied by the first resistance force application portion when coming into contact with the first resistance force application portion;
a second contact region that is provided on the outer circumferential surface of the main body of the article, and that comes into contact with the first resistance force application portion along with the rotation caused by the contact between the first contact region and the first resistance force application portion and slides the main body of the article with respect to the first resistance force application portion to make sliding movement of the main body of the article;
a third contact region that is provided on the outer circumferential surface of the main body of the article, and that comes into contact with the second resistance force application portion along with the sliding movement and rotates the main body of the article in the circumferential direction by using the resistance force applied by the second resistance force application portion; and
a fourth contact region that is provided on the outer circumferential surface of the main body of the article, and that comes into contact with the second resistance force application portion along with the rotation caused by the contact between the third contact region and the second resistance force application portion and slides the main body of the article with respect to the second resistance force application portion to make sliding movement of the main body of the article.

19. An inspection system comprising:
an article;
a conveyance device that conveys the article; and
an inspection unit that inspects the article to be conveyed by the conveyance device, wherein
the conveyance device comprises:
a conveyance unit that conveys the article along a predetermined conveyance route;
a first resistance force application portion that has a plurality of projection portions arranged at a plurality of positions in a conveyance direction of the article and projecting to the conveyance route, and that comes into contact with a side of the article to be conveyed in the conveyance route and applies resistance force to the article; and
a second resistance force application portion that has a plurality of projection portions arranged at a plurality of positions in the conveyance direction of the article and projecting to the conveyance route, that is arranged on a downstream side of the first resistance force application portion in the conveyance direction of the article and at a position different from the first resistance force application portion in a height direction, and that comes into contact with the side of the article to be conveyed in the conveyance route and applies resistance force to the article,
the article comprises:
a main body of the article;
a plurality of first contact portions that are arranged within a predetermined range in a circumferential direction of the main body of the article and are arranged in the circumferential direction, and that are capable of coming into contact with the plurality of projection portions provided in the first resistance force application portion;
a first region that is located at a portion adjacent to the predetermined range in the circumferential direction, and that does not have the plurality of first contact portions;
a plurality of second contact portions that are arranged within a predetermined range in the circumferential direction of the main body of the article and are arranged in the circumferential direction, and that are capable of coming into contact with the plurality of projection portions provided in the second resistance force application portion; and
a second region that is located at a portion adjacent to the predetermined range where the plurality of second contact portions are provided, and that does not have the plurality of second contact portions, wherein
the plurality of first contact portions of the article moving in the conveyance route sequentially come into contact with the plurality of projection portions provided in the first resistance force application portion and thereby the article rotates in the circumferential direction, the first region faces a side where the plurality of projection portions are provided along with the rotation and thereby the rotation of the article stops, the plurality of second contact portions of the article sequentially come into contact with the plurality of projection portions provided in the second resistance force application portion and thereby rotation of the article restarts, and the second region faces a side where the plurality of projection portions are provided along with the rotation and thereby the rotation of the article stops.
